(19) United States
(12) Patent Application Publication
(10) Pub. No.: US 2019/0188640 A1
(43) Pub. Date: Jun. 20, 2019

(54) STOCK MANAGEMENT DEVICE, CUSTOMER TERMINAL, AND STOCK MANAGEMENT METHOD

(71) Applicant: NEC Corporation, Minato-ku, Tokyo (JP)

(72) Inventors: Hiromi YAMAGUCHI, Tokyo (JP); Shinji NAKADAI, Tokyo (JP)

(73) Assignee: NEC Corporation, Minato-ku, Tokyo (JP)

(21) Appl. No.: 16/327,416

(22) PCT Filed: Aug. 22, 2017
(86) PCT No.: PCT/JP2017/029876

§ 371 Date: Feb. 22, 2019

(30) Foreign Application Priority Data
Aug. 23, 2016 (JP) 2016-162596

(51) Int. Cl. G06Q 10/08

(52) U.S. Cl. CPC G06Q 10/08355; G06Q 10/087; G06Q 10/0832; G06Q 10/0833

(57) ABSTRACT

Provide a stock management device capable of bringing both a benefit of online shopping and a benefit by using a mobile sales vehicle to a customer purchasing an item by online shopping. This stock management device is provided with: management means for managing stock information about stock of an item held by each of a plurality of mobile sales vehicles performing mobile sale; first reception means for receiving sales information indicating and current position information; second reception means for receiving order information and desired delivery time information and delivery address information; first specification means for specifying a mobile sales vehicle capable of delivering the item by the desired delivery time; first transmission means for transmitting the stock information and transmitting the stock information; and second transmission means for transmitting the order information, wherein the management means updates the stock information.

### TECHNICAL FIELD

The present disclosure relates to a stock management device, a customer terminal, an item sales system, a stock management method, a display control method, and a recording medium.

There are an increasing of doing online shopping to purchase an item through the Internet. Further, an item sales method called a mobile supermarket using a mobile sales vehicle has been proposed (NPL 1).

As a technology of combining the above, a technology of ordering, through a network, an item being sold by a mobile sales vehicle and purchasing the ordered item at a mobile sales vehicle is disclosed (PTL 1).

Further, as a technology related to online shopping, for example, a method of supporting in-store picking of an item to be ordered is described in PTL 2.

Further, PTL 3 describes a technology of, when an item purchased at a store is desired to be delivered, transmitting information of the item and information of a delivery address to a mobile sales vehicle, and delivering the item picked from the mobile sales vehicle to a user desiring delivery.

### CITATION LIST

### Patent Literature

PTL 1: Japanese Unexamined Patent Application Publication No. 2011-221984
PTL 2: Japanese Unexamined Patent Application Publication No. 2009-151623
PTL 3: Japanese Unexamined Patent Application Publication No. 2002-269641

### Non Patent Literature

NPL 1: “Mobile Supermarket Tokushimaru,” [online], [retrieved on Jul. 13, 2016], retrieved from the Internet: <http://www.tokushimaru.jp/>

### SUMMARY OF INVENTION

### Technical Problem

Item purchase by online shopping takes at least several hours from ordering of an item to delivery to the purchaser, and therefore it takes a long time for actual delivery after ordering. However, in the case of item purchase by online shopping, for example, there is a benefit that a customer staying indoors can receive an item without going outdoors. Further, in item sale by a mobile sales vehicle, an item is displayed on a luggage carrier of the mobile sales vehicle as is the case with a common supermarket, and therefore a customer can actually take an item in hand and purchase the item at the mobile sales vehicle. Accordingly, for example, when a supermarket does not exist close to a customer and a mobile sales vehicle sells items close to the customer, there is a benefit that the customer can get an item to be purchased at a storefront of the mobile sales vehicle, without visiting a distant supermarket. A technology allowing a customer to acquire both such a benefit of using online shopping and such a benefit by using a mobile sales vehicle is being sought. In order to acquire the both benefits, the present inventors have found a method for unitarily managing stock of items being sold at a mobile sales vehicle and stock of items being sold on online shop. When the technology is used, a customer using online shopping may want to get an item by a desired time.

An object of the present disclosure is to provide both a benefit of online shopping and a benefit by using a mobile sales vehicle to a customer purchasing an item by online shopping, and to further provide the customer with information of an item that can be delivered by a time desired by the customer.

### Solution to Problem

A stock management device according to one aspect of the present disclosure includes:

management means for managing stock information about stock of an item held by each of a plurality of mobile sales vehicles performing mobile sale;

first reception means for receiving, from each of the plurality of mobile sales vehicles, sales information indicating an item sold at a storefront of the mobile sales vehicle and current position information indicating a current position of the mobile sales vehicle;

second reception means for receiving, from a customer terminal, order information including information about an item ordered based on the stock information transmitted to the customer terminal, the second reception means further receiving, from the customer terminal, desired delivery time information at which a customer desires the item to be delivered and delivery address information indicating a delivery address of the item;

first specification means for specifying, when the second reception means receives information indicating the desired delivery time, a mobile sales vehicle capable of delivering the item to the delivery address by the desired delivery time, based on the current position of the mobile sales vehicle indicated by the current position information, and a position of the delivery address indicated by the delivery address information;

first transmission means for transmitting the stock information to the customer terminal, the first transmission means transmitting, to the customer terminal, the stock information about stock held by the mobile sales vehicle specified by the first specification means; and

second transmission means for transmitting the order information along with the delivery address information to the mobile sales vehicle delivering the ordered item, wherein

the management means updates the stock information, based on at least one of the sales information or the order information.

A customer terminal according to one aspect of the present disclosure includes:

transmission means for transmitting desired delivery time information of an item a customer desires delivery and delivery address information indicating a delivery address of then item to a stock management device managing stock information about stock of an item held by each of a plurality of mobile sales vehicles performing mobile sale;

reception means for receiving, from the stock management device, stock information about stock held by a mobile sales vehicle capable of delivering the item to the delivery address by the desired delivery time; and

display control means for causing a display device to display the desired delivery time in a selectable manner and further causing the display device to display an ordering screen for receiving an order from a customer, the ordering screen being generated based on the stock information.

An item sales system according to one aspect of the present disclosure includes:

a stock management device;

an on-board device being loaded on each of a plurality of mobile sales vehicles performing mobile sale and transmitting, to a stock management device, sales information indicating an item sold at a storefront of each of the plurality of mobile sales vehicles and current position information indicating a current position of the mobile sales vehicle; and

one or more customer terminals, wherein

the stock management device includes:
management means for managing stock information about stock of an item held by each of the plurality of mobile sales vehicles;
first reception means for receiving the sales information and the current position information from each of the plurality of mobile sales vehicles;
second reception means for receiving, from the customer terminal, order information including information about an item ordered based on the stock information transmitted to the customer terminal, the second reception means further receiving, from the customer terminal, desired delivery time information at which a customer desires the item to be delivered and delivery address information indicating a delivery address of the item;
first specification means for specifying, when the second reception means receives information indicating the desired delivery time, a mobile sales vehicle capable of delivering the item to the delivery address by the desired delivery time, based on the current position of the mobile sales vehicle indicated by the current position information, and a position of the delivery address indicated by the delivery address information;
first transmission means for transmitting the stock information to the customer terminal, the first transmission means transmitting, to the customer terminal, the stock information about stock held by the mobile sales vehicle specified by the first specification means; and
second transmission means for transmitting the order information to the mobile sales vehicle delivering the ordered item, wherein

the management means updates the stock information, based on at least one of the sales information and the order information.

A stock management method according to one aspect of the present disclosure includes:

managing stock information about stock of an item held by each of a plurality of mobile sales vehicles performing mobile sale;

receiving, from each of the plurality of mobile sales vehicles, sales information indicating an item sold at a storefront of the mobile sales vehicle and current position information indicating a current position of the mobile sales vehicle;

transmitting the stock information to a customer terminal;

receiving, from the customer terminal, desired delivery time information at which a customer desires an item to be delivered;

receiving, from the customer terminal, delivery address information indicating a delivery address of the item;

specifying when receiving information indicating the desired delivery time, a mobile sales vehicle capable of delivering the item to the delivery address by the desired delivery time, based on the current position of the mobile sales vehicle indicated by the current position information, and a position of the delivery address indicated by the delivery address information;

transmitting, to the customer terminal, the stock information about stock held by the mobile sales vehicle specified;

receiving, from the customer terminal, order information including information about an item ordered based on the stock information;

transmitting the order information along with the delivery address information to the mobile sales vehicle delivering the ordered item; and

updating the stock information, based on at least one of the sales information and the order information.

A display control method according to one aspect of the present disclosure includes:

causing a display device to display a desired delivery time of an item in a selectable manner;

transmitting information indicating a selected desired delivery time and delivery address information indicating a delivery address of the item to a stock management device managing stock information about stock of an item held by each of a plurality of mobile sales vehicles performing mobile sale;

receiving, from the stock management device, stock information about stock held by a mobile sales vehicle capable of delivering the item to the delivery address by the desired delivery time; and

causing the display device to display an ordering screen for receiving an order from a customer, the ordering screen being generated based on the stock information.

A stock management method in an item sales system including a stock management device, an on-board device loaded on each of a plurality of mobile sales vehicles performing mobile sale, and one or more customer terminals, the stock management method according to one aspect of the present disclosure includes:

managing, by the stock management device, stock information about stock of an item held by each of the plurality of mobile sales vehicles;

transmitting, by the on-board device, to the stock management device, sales information indicating an item sold at a storefront of the mobile sales vehicle loaded with the on-board device and current position information indicating a current position of the mobile sales vehicle;

receiving, by the stock management device, the sales information and the current position information;

transmitting, by the stock management device, the stock information to the customer terminal;

transmitting, by the customer terminal, desired delivery time information of an item a customer desires delivery;

transmitting, by the customer terminal, delivery address information indicating a delivery address of the item;

receiving, by the stock management device, information indicating the desired delivery time from the customer terminal;

receiving, by the stock management device, delivery address information indicating a delivery address of the item from the customer terminal;

based on a current position of the mobile sales vehicle indicated by the current position information, and a position of the delivery address indicated by the delivery address information, specifying, by the stock management device, a mobile sales vehicle capable of delivering the item to the delivery address by the desired delivery time, when receiving information indicating the desired delivery time;

transmitting, by the stock management device to the customer terminal, the stock information about stock held by the specified mobile sales vehicle;

receiving, by the customer terminal, the stock information;

transmitting, by the customer terminal, to the stock management device, order information including information about an item ordered based on the stock information;

receiving, by the stock management device, the order information from the customer terminal;

transmitting, by the stock management device, the order information along with the delivery address information to the mobile sales vehicle delivering the ordered item; and

updating, by the stock management device, the stock information, based on at least one of the sales information and the order information.

A computer program implementing, with a computer, the stock management device, the customer terminal, the item sales system, or the respective methods that are described above, and a computer-readable, non-transitory recording medium storing the computer program are also included in the scope of the present disclosure.

### Advantageous Effects of Invention

The present disclosure is capable of bringing both a benefit of online shopping and a benefit by using a mobile sales vehicle to a customer purchasing an item by online shopping, and further capable of providing the customer with information of an item that can be delivered by a time desired by the customer.

### BRIEF DESCRIPTION OF DRAWINGS

FIG. 1 is a functional block diagram illustrating a functional configuration example of a stock management device according to a first example embodiment.

FIG. 2 is a flowchart illustrating an example of a processing flow in the stock management device according to the first example embodiment.

FIG. 3 is a functional block diagram illustrating a functional configuration example of a customer terminal communicating with the stock management device according to the first example embodiment.

FIG. 4 is a flowchart illustrating an example of a processing flow in the customer terminal communicating with the stock management device according to the first example embodiment.

FIG. 5 is a functional block diagram illustrating a functional configuration example of an item sales system including the stock management device according to the first example embodiment.

FIG. 6 is a flowchart illustrating an example of a processing flow in the item sales system including the stock management device according to the first example embodiment.

FIG. 7 is a block diagram illustrating a configuration example of an item sales system according to a second example embodiment.

FIG. 8 is a diagram for illustrating a use scene of the item sales system according to the second example embodiment.

FIG. 9 is a functional block diagram illustrating a functional configuration example of a stock management device in the item sales system according to the second example embodiment.

FIG. 10 is a diagram illustrating an example of stock information stored by a stock information storage unit according to the second example embodiment.

FIG. 11 is a diagram illustrating an example of customer information stored by a customer information storage unit according to the second example embodiment.

FIG. 12 is a functional block diagram illustrating a functional configuration example of an on-board device in the item sales system according to the second example embodiment.

FIG. 13 is a functional block diagram illustrating a functional configuration example of a customer terminal in the item sales system according to the second example embodiment.

FIG. 14 is a flowchart illustrating an example of a processing flow of updating stock information, based on sales information, in the item sales system according to the second example embodiment.

FIG. 15 is a flowchart illustrating an example of a flow of transmission processing of state information by the on-board device in the item sales system according to the second example embodiment.

FIG. 16 is a flowchart illustrating an example of a flow of sales processing of an item by online shopping in the item sales system according to the second example embodiment.

FIG. 17 is a flowchart illustrating an example of a flow of the sales processing of an item by online shopping in the item sales system according to the second example embodiment.

FIG. 18 is a diagram illustrating an example of an ordering screen displayed by a display unit.

FIG. 19 is a diagram illustrating another example of an ordering screen displayed by the display unit.

FIG. 20 is a diagram illustrating an example of a confirmation screen displayed by the display unit.

FIG. 21 is a diagram illustrating an example of an ordered items confirmation screen displayed by the display unit.

FIG. 22 is a diagram illustrating another example of an ordered items confirmation screen displayed by the display unit.

FIG. 23 is a diagram illustrating another example of an ordering screen displayed by the display unit.

FIG. 24 is a diagram exemplarily illustrating a hardware configuration of a computer (information processing device) capable of implementing the respective example embodiments.

### DESCRIPTION OF EMBODIMENTS

### First Example Embodiment

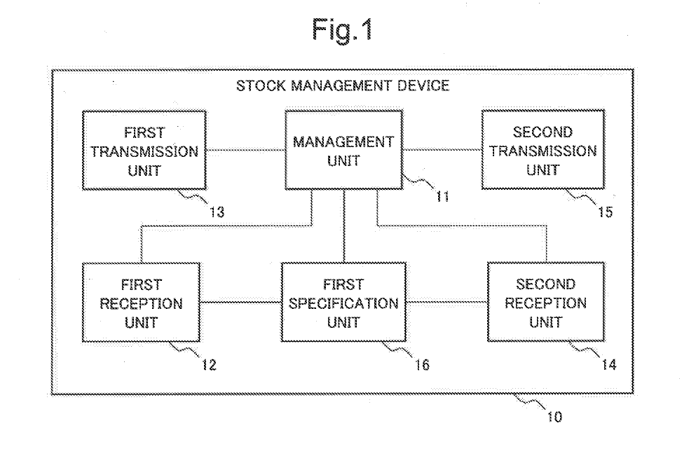

A first example embodiment of the present disclosure will be described with reference to drawings. A stock management device 10 managing stock information about stock of an item held by each of a plurality of mobile sales vehicles will be described in the present example embodiment. A mobile sales vehicle is a vehicle capable of moving to a predetermined location in accordance with a predetermined traveling route or in a predetermined area, and selling items loaded on a luggage carrier of the vehicle, at the destination. A mobile sales vehicle can also receive an order for items loaded on the vehicle, while opening a luggage carrier and selling items loaded on the luggage carrier, or through a network while moving. Then, based on the received order, the mobile sales vehicle delivers the item to a customer who ordered. As described above, a mobile sales vehicle sells an item loaded on itself not only at its storefront but also through a network, and therefore selling items displayed at the storefront may compete with selling through a network. A technology of providing both a benefit of online shopping and a benefit of using a mobile sales vehicle even when items are in such a competition will be described in the present disclosure. FIG. 1 is a functional block diagram illustrating a functional configuration example of a stock management device 10 according to the present example embodiment. As illustrated in FIG. 1, the stock management device 10 according to the present example embodiment includes a management unit 11, a first reception unit 12, a first transmission unit 13, a second reception unit 14, and a second transmission unit 15, and a first specification unit 16.

The management unit 11 manages stock information about stock of an item held by each of a plurality of mobile sales vehicles. The stock information includes at least information (for example, an item name and an item identifier) for identifying an item held by each of the plurality of mobile sales vehicles and a quantity of the item. The management unit 11 manages stock information for each mobile sales vehicle. Stock information managed by the management unit 11 may be stored in a storage unit provided inside the stock management device 10 or may be stored in a storage device separate from the stock management device 10.

Further, the management unit 11 updates stock information, based on sales information received by the first reception unit 12 and/or order information received by the second reception unit 14.

Further, when receiving information indicating a mobile sales vehicle from the first specification unit 16, the management unit 11 provides the first transmission unit 13 with stock information about stock held by the mobile sales vehicle indicated by the information indicating the mobile sales vehicle.

The first reception unit 12 receives, from each of a plurality of mobile sales vehicles, sales information indicating an item sold at its storefront and current position information indicating a current position of the mobile sales vehicle. The sales information includes at least information (for example, an item name and an item identifier) for identifying an item sold at the storefront of the mobile sales vehicle and a quantity of the item. The first reception unit 12 provides the received sales information to the management unit 11. Further, the first reception unit 12 provides the received current position information to the first specification unit 16.

The second reception unit 14 receives, from a customer terminal to which stock information has been transmitted by the first transmission unit 13, order information including information about an item ordered based on the stock information. The information about the ordered item, the information being included in the order information, includes at least information for identifying a customer ordering the item, information (for example, an item name and an item identifier) for identifying the ordered item, the item being included in the stock information managed by the management unit 11, and a quantity of the item. The second reception unit 14 provides the received order information to the management unit 11.

Further, when desired delivery time information is transmitted from a customer terminal, the second reception unit 14 receives the desired delivery time information. The desired delivery time represents a time at which a customer desires an item to be delivered. A desired delivery time may represent a time period such as from M o'clock to N o'clock. The second reception unit 14 provides the received information indicating the desired delivery time to the first specification unit 16.

Further, when receiving delivery address information indicating a delivery address of an item from a customer terminal, the second reception unit 14 provides the received delivery address information to the first specification unit 16.

When the second reception unit 14 receives desired delivery time information from a customer terminal, the first specification unit 16 receives the information indicating the desired delivery time from the second reception unit 14. Further, the first specification unit 16 receives current position information from the first reception unit 12. Further, the first specification unit 16 receives delivery address information from the second reception unit 14.

Based on a current position of the mobile sales vehicle indicated by the current position information and a position of a delivery address indicated by the delivery address information, the first specification unit 16 specifies a mobile sales vehicle capable of delivering an item to the delivery address by the desired delivery time. The first specification unit 16 provides information indicating the specified mobile sales vehicle to the management unit 11.

The first transmission unit 13 transmits stock information to a customer terminal. Further, when a mobile sales vehicle is specified by the first specification unit 16, the first transmission unit 13 transmits, to the customer terminal, stock information about stock held by the specified mobile sales vehicle, the stock information being provided from the management unit 11.

The second transmission unit 15 transmits order information along with delivery address information to a mobile sales vehicle holding an ordered item. Specifically, the second transmission unit 15 receives, from the management unit 11, information indicating a mobile sales vehicle holding an ordered item, along with order information, and transmits the order information along with delivery address information to the mobile sales vehicle.

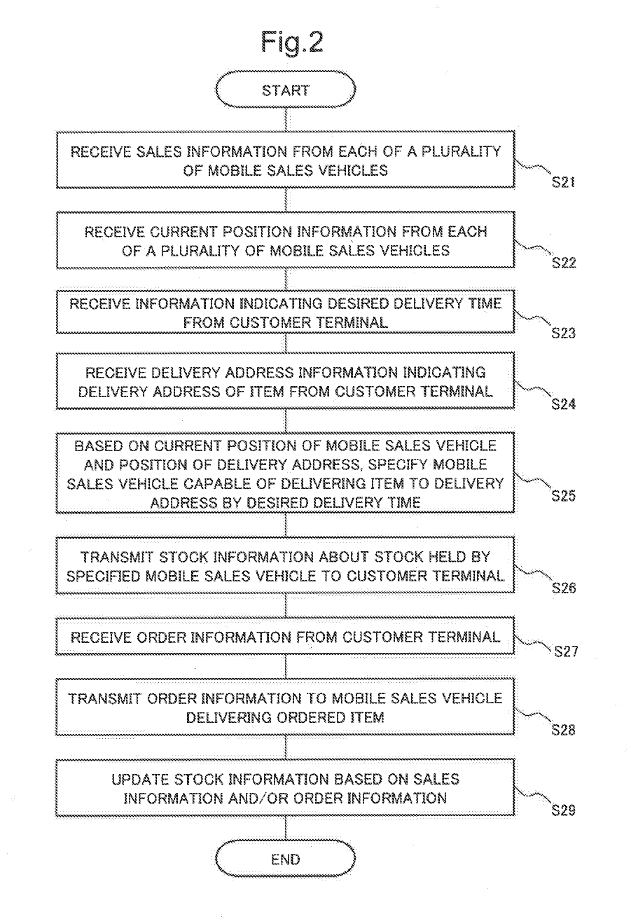

Next, a processing flow in the stock management device 10 according to the present example embodiment will be described with reference to FIG. 2. FIG. 2 is a flowchart illustrating an example of a processing flow in the stock management device 10 according to the present example embodiment. It is assumed in FIG. 2 that the management unit 11 in the stock management device 10 manages stock information about stock of an item held by a plurality of mobile sales vehicles, for each mobile sales vehicle. It is further assumed that the first transmission unit 13 in the stock management device 10 has transmitted stock information to a customer terminal. The description in the flowchart illustrated in FIG. 2 assumes that the stock management device 10 receives desired delivery time information from a customer terminal.

As illustrated in FIG. 2, first, the first reception unit 12 in the stock management device 10 receives, from each of a plurality of mobile sales vehicles, sales information indicating an item sold at the storefront of the mobile sales vehicle (Step S21). Further, the first reception unit 12 receives, from each of a plurality of mobile sales vehicles, current position information indicating a current position of the mobile sales vehicle (Step S22).

Further, the second reception unit 14 receives desired delivery time information from a customer terminal (Step S23). Further, the second reception unit 14 receives delivery address information indicating a delivery address of an item from the customer terminal (Step S24). Steps S21 to S24 may be performed in any order.

When Steps S22 to S24 end, the first specification unit 16 specifies a mobile sales vehicle capable of delivering an item to the delivery address by the desired delivery time, based on a current position of the mobile sales vehicle indicated by the current position information, and a position of the delivery address indicated by the delivery address information (Step S25).

Then, the first transmission unit 13 transmits, to the customer terminal, stock information about stock held by the mobile sales vehicle specified in Step S25 (Step S26).

Then, the second reception unit 14 receives, from the customer terminal to which the stock information has been transmitted by the first transmission unit 13 in Step S26, order information including information about an item ordered based on the stock information (Step S27).

Then, the second transmission unit 15 transmits the order information along with the delivery address information to a mobile sales vehicle being to deliver the ordered item (Step S28).

When Step S21 and/or S25 ends, the management unit 11 updates the stock information, based on the sales information and/or the order information (Step S29). Specifically, when Step S21 ends, the management unit 11 updates stock information about stock held by a mobile sales vehicle transmitting sales information, based on the sales information. Further, when Step S28 ends, the management unit 11 updates stock information about stock held by a mobile sales vehicle to which the second transmission unit 15 transmitted the order information, based on the order information.

The above concludes the processing by the stock management device 10.

As described above, the management unit 11 updates stock information based on at least one of sales information received by the first reception unit 12 and order information received by the second reception unit 14. The stock management device 10 manages both stock for mobile sale by a mobile sales vehicle and stock for an online shop. Thus, the stock management device 10, for example, reflects stock for mobile sale in which items sold by mobile sale to stock for an online shop. Further, for example, when an order for an item is placed by an online shop, stock information about stock of items available for sale at a mobile sales vehicle is also updated. Consequently, both a customer using a mobile sales vehicle and a customer doing online shopping can confirm items in stock purchasable at the time. Accordingly, items held by a mobile sales vehicle can be sold both at the mobile sales vehicle and on an online shop.

Further, the second transmission unit 15 transmits order information to a mobile sales vehicle being to deliver an ordered item. Consequently, a driver of a mobile sales vehicle receiving the order information can deliver an item to a customer who ordered the item held by the mobile sales vehicle.

Further, based on a current position of the mobile sales vehicle and a position of a delivery address, the first specification unit 16 specifies a mobile sales vehicle capable of delivering an item to a delivery address by a desired delivery time. Then, the first transmission unit 13 transmits stock information about stock held by the specified mobile sales vehicle to a customer terminal. Consequently, a customer doing online shopping by use of the customer terminal can confirm stock information about stock held by the mobile sales vehicle capable of delivering an item by a desired time. Accordingly, the customer can do online shopping while understanding whether or not an item of which the customer desires to purchase can be delivered by a desired time.

Accordingly, the stock management device 10 according to the present example embodiment is capable of bringing both a benefit of online shopping and a benefit by using a mobile sales vehicle to a customer purchasing an item by online shopping, and further capable of providing the customer with information of an item that can be delivered by a time desired by the customer.

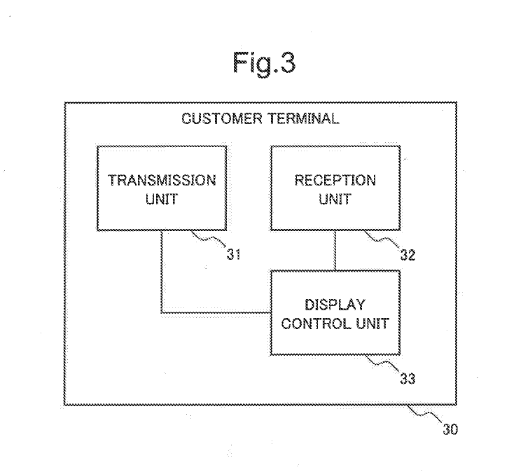

Next, a customer terminal communicating with the stock management device 10 will be described. FIG. 3 is a functional block diagram illustrating a functional configuration example of a customer terminal 30 communicating with the stock management device 10 according to the present example embodiment.

As illustrated in FIG. 3, the customer terminal 30 includes a transmission unit 31, a reception unit 32, and a display control unit 33. The transmission unit 31 transmits, to the aforementioned stock management device 10, desired delivery time information of an item and delivery address information indicating a delivery address of the item.

The reception unit 32 receives, from the aforementioned stock management device 10, stock information about stock held by a mobile sales vehicle capable of delivering an item to a delivery address by a desired delivery time. The reception unit 32 provides the received stock information to the display control unit 33.

The display control unit 33 causes a display device to display desired delivery times in a selectable manner. Consequently, the aforementioned transmission unit 31 transmits desired delivery time information selected by a customer from the desired delivery times thus displayed on the display device.

Further, the display control unit 33 causes the display device to display an ordering screen for receiving an order from a customer, the ordering screen being generated based on stock information.

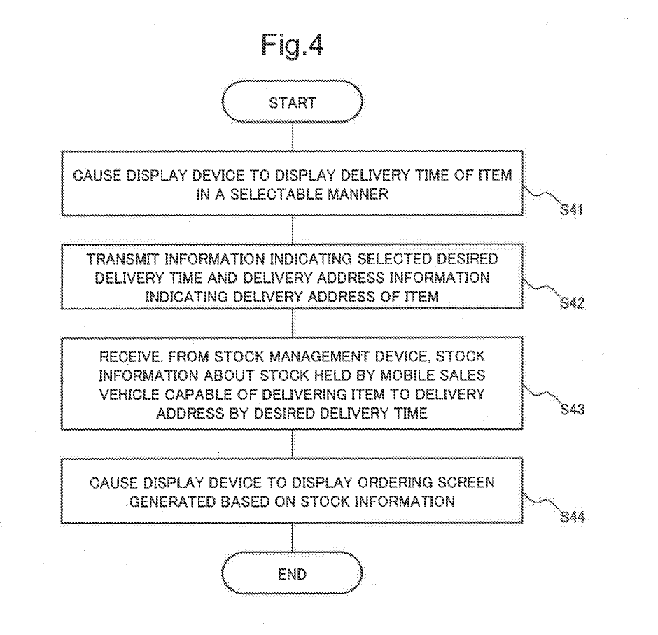

Next, a processing flow in the customer terminal 30 will be described with reference to FIG. 4. FIG. 4 is a flowchart illustrating an example of a processing flow in a customer terminal 30 communicating with the stock management device 10 according to the present example embodiment.

First, the display control unit 33 causes the display device to display desired delivery times of items in a selectable manner (Step S41). Then, when a desired delivery time is selected by a customer, the transmission unit 31 transmits, to the stock management device 10, information indicating the selected desired delivery time and delivery address information indicating a delivery address of an item (Step S42). The delivery address of the item may be input by the customer or may be preset.

Then, the reception unit 32 receives, from the stock management device 10, stock information about stock held by a mobile sales vehicle capable of delivering an item to the delivery address by the desired delivery time (Step S43). Then, the display control unit 33 causes the display device to display an ordering screen for receiving an order from the customer, the ordering screen being generated based on the stock information (Step S44).

The above concludes the processing by the customer terminal 30.

As described above, the customer terminal 30 displays an ordering screen based on stock information about stock held by a mobile sales vehicle capable of delivering an item to a delivery address by a desired delivery time, the stock information being transmitted from the stock management device 10. Accordingly, a customer doing online shopping by use of the customer terminal 30 can do online shopping while understanding whether or not items of which the customer desires to purchase can be delivered by a desired time. Consequently, for example, when a customer doing online shopping prefers to securely get items that the customer desires to purchase, the customer can take a measure of ordering items not being sold at a storefront of a mobile sales vehicle at the time.

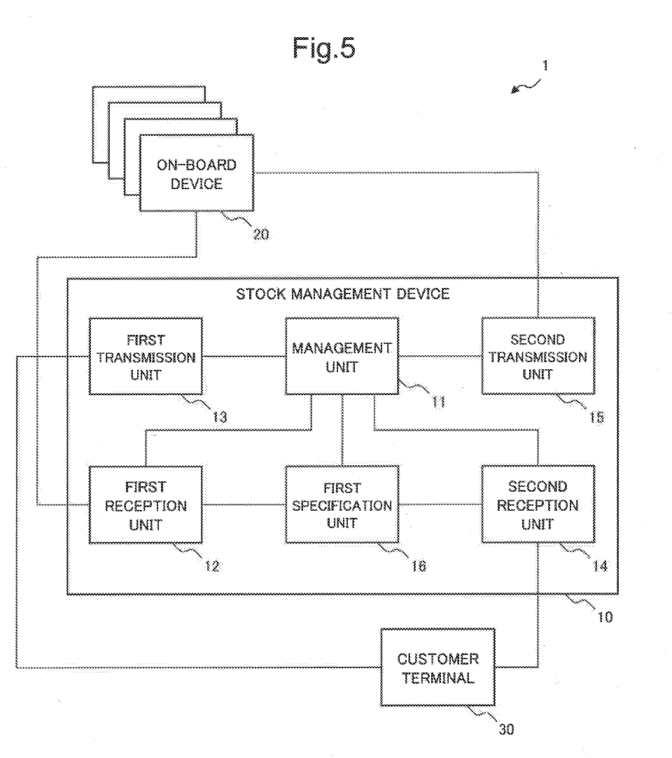

Further, an item sales system 1 including the stock management device 10 according to the present example embodiment will be described with reference to FIG. 5. FIG. 5 is a functional block diagram illustrating a functional configuration example of the item sales system 1 including the stock management device 10 according to the present example embodiment. As illustrated in FIG. 5, the item sales system 1 includes the stock management device 10, a plurality of on-board devices 20, and one or a plurality of customer terminals 30. The stock management device 10 included in FIG. 5 has a configuration similar to that of the stock management device 10 described by use of FIG. 1. Further, the customer terminal 30 included in FIG. 5 includes a function similar to that of the customer terminal 30 described by use of FIG. 3.

An on-board device 20 is loaded on each of a plurality of mobile sales vehicles and transmits, to the stock management device 10, sales information indicating an item sold at the storefront of each of the plurality of mobile sales vehicles. Further, an on-board device 20 transmits, to the stock management device 10, current position information indicating a current position of the mobile sales vehicle loaded with the on-board device 20. Then, a first reception unit 12 in the stock management device 10 receives the sales information and the state information.

A second reception unit 14 in the stock management device 10 receives, from a customer terminal 30, desired delivery time information and delivery address information. Then, based on a current position of the mobile sales vehicle indicated by current position information and a position of a delivery address indicated by the delivery address information, the first specification unit 16 in the stock management device 10 specifies a mobile sales vehicle capable of delivering an item to the delivery address by the desired delivery time. Subsequently, a first transmission unit 13 in the stock management device 10 transmits stock information about stock held by the specified mobile sales vehicle to the customer terminal 30.

Further, a second reception unit 14 in the stock management device 10 receives order information transmitted from each customer terminal 30.

A management unit 11 in the stock management device 10 updates stock information, based on at least one of sales information received by the first reception unit 12 and order information received by the second reception unit 14.

Further, a second transmission unit 15 transmits order information to an on-board device 20 on a mobile sales vehicle holding an ordered item included in the order information.

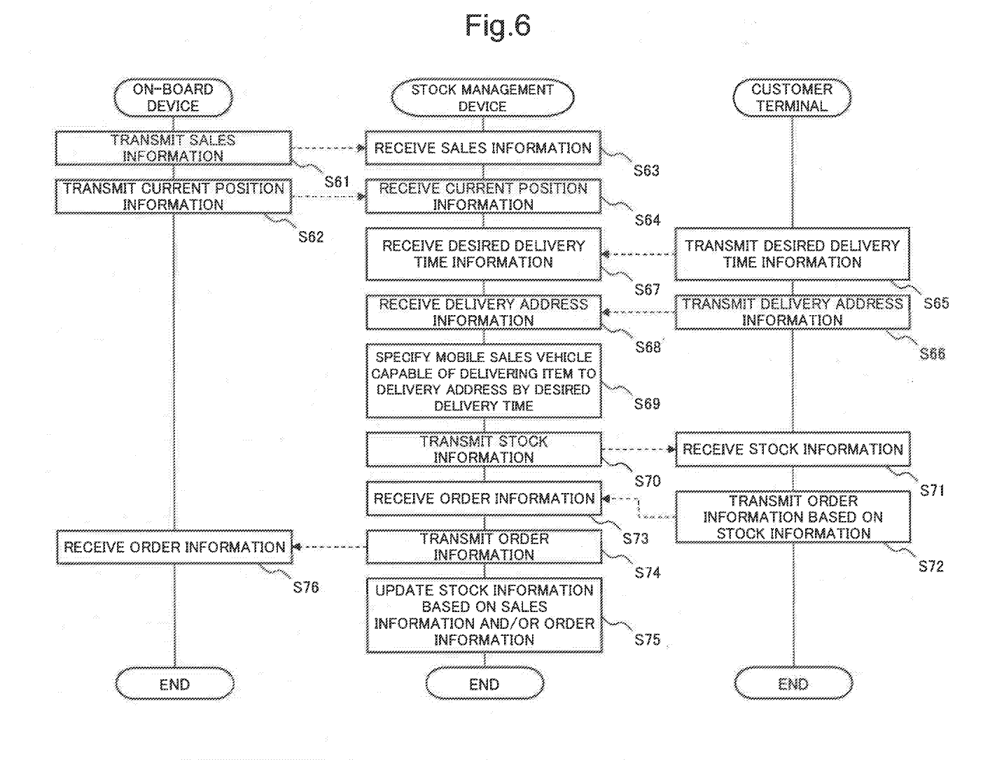

Next, a processing flow in the item sales system 1 including the stock management device 10 according to the present example embodiment will be described with reference to FIG. 6. FIG. 6 is a flowchart illustrating an example of a processing flow in the item sales system 1 including the stock management device 10 according to the present example embodiment. It is assumed in FIG. 6 that the management unit 11 in the stock management device 10 manages stock information about stock of an item held by a plurality of mobile sales vehicles, for each mobile sales vehicle. It is further assumed that the first transmission unit 13 in the stock management device 10 has transmitted stock information to a customer terminal 30. The description in the flowchart illustrated in FIG. 6 assumes that the stock management device 10 receives desired delivery time information from a customer terminal 30.

Further, in FIG. 6, processing by an on-board device 20 is described on the left, processing by the stock management device 10 at the center, and processing by a customer terminal 30 on the right; and a broken arrow between the respective processing steps represents a flow of primary information. An information flow is not limited to a direction of an arrow, and for example, an ACKnowledgement (ACK) may be transmitted in a direction reverse to the arrow.

As illustrated in FIG. 6, an on-board device 20 transmits, to the stock management device 10, sales information indicating an item sold at a storefront of a mobile sales vehicle loaded with the on-board device 20 (Step S61). Further, the on-board device 20 transmits, to the stock management device 10, current position information indicating a current position of the mobile sales vehicle loaded with the on-board device 20 (Step S62). Steps S61 and S62 may be performed at a time or may be performed in reverse order.

The first reception unit 12 in the stock management device 10 receives the sales information (Step S63). Further, the first reception unit 12 receives the current position information (Step S64).

Further, the transmission unit 31 in a customer terminal 30 transmits desired delivery time information (Step S65). Further, the transmission unit 31 transmits delivery address information indicating a delivery address of an item (Step S66). Steps S65 and S66 may be performed at a time or may be performed in reverse order.

The transmission processing of desired delivery time information and the transmission processing of delivery address information by the customer terminal 30 are performed asynchronously with the transmission processing of sales information and the transmission processing of current position information by the on-board device 20, and an execution order thereof is not particularly limited.

Then, the second reception unit 14 in the stock management device 10 receives the information indicating the desired delivery time from the customer terminal 30 (Step S67). Further, the second reception unit 14 receives, from the customer terminal 30, the delivery address information indicating the delivery address of an item (Step S68).

Then, based on a current position of the mobile sales vehicle indicated by current position information and a position of the delivery address indicated by the delivery address information, the first specification unit 16 specifies a mobile sales vehicle capable of delivering an item to the delivery address by the desired delivery time (Step S69).

Then, the first transmission unit 13 transmits, to the customer terminal 30, stock information of the mobile sales vehicle specified in Step S69 (Step S70). In a case that the first transmission unit 13 has transmitted each stock information of each mobile sales vehicles when initially having transmitted the stock information to the customer terminal 30, the first transmission unit 13 may transmit information indicating the specified mobile sales vehicle in place of the stock information of the specified mobile sales vehicle.

The reception unit 32 in the customer terminal 30 receives the stock information from the stock management device 10 (Step S71). In a case that the reception unit 32 receives each stock information of each mobile sales vehicles when initially transmitting the stock information from the stock management device 10, the reception unit 32 may receive information indicating the specified mobile sales vehicle in place of the stock information of the specified mobile sales vehicle. Consequently, the display control unit 33 can display, on the display device, only stock information of a mobile sales vehicle indicated by the information indicating the specified mobile sales vehicle, in the initially received stock information.

Then, the transmission unit 31 transmits, to the stock management device 10, order information including information about an item ordered based on the displayed stock information (Step S72).

The second reception unit 14 in the stock management device 10 receives, from the customer terminal 30, the order information including the information about the item ordered based on the stock information (Step S73).

Then, the second transmission unit 15 transmits the order information along with the delivery address information to the mobile sales vehicle being to deliver the ordered item (Step S74).

When Step S63 and/or S74 ends, the management unit 11 updates the stock information, based on the sales information and/or the order information (Step S75). Specifically, when updating, based on the sales information, the stock information, the management unit 11 updates, based on the sales information, stock information about stock held by the mobile sales vehicle having transmitted the sales information. Further, when updating, based on the order information, the stock information, the management unit 11 updates, based on the order information, stock information about stock held by the mobile sales vehicle to which the order information has been transmitted by the second transmission unit 15 in Step S74.

When Step S74 ends, the on-board device 20 receives the order information (Step S76).

When an item is purchased at a mobile sales vehicle loaded with an on-board device 20, Step S61 is executed again in the item sales system 1. Further, when an order is placed for an item by a customer terminal 30, Step S72 is executed again.

Thus, every time a customer purchases an item, the processing in the flowchart illustrated in FIG. 6 is executed in the stock management device 10.

As described above, in the item sales system 1, the management unit 11 in the stock management device 10 updates stock information, based on sales information received by the first reception unit 12 and order information received by the second reception unit 14. Further, the second transmission unit 15 transmits order information to an on-board device 20 on a mobile sales vehicle holding an ordered item included in the order information. Consequently, the mobile sales vehicle loaded with the on-board device 20 can deliver the ordered item to a customer ordering the item.

Further, based on a current position of the mobile sales vehicle and a position of a delivery address, the first specification unit 16 in the stock management device 10 specifies a mobile sales vehicle capable of delivering items to the delivery address by a desired delivery time. Then, the first transmission unit 13 transmits stock information about stock held by the specified mobile sales vehicle. Consequently, a customer doing online shopping by use of a customer terminal 30 can confirm stock information about stock held by a mobile sales vehicle capable of delivering items by a desired time. Accordingly, the customer can do online shopping while understanding whether or not items of which the customer desires to purchase can be delivered by the desired time.

Accordingly, the item sales system 1 including the stock management device 10 according to the present example embodiment is capable of bringing both a benefit of online shopping and a benefit by using a mobile sales vehicle to a customer purchasing an item by online shopping, and further capable of providing the customer with information of an item that can be delivered by a time desired by the customer.

### Second Example Embodiment

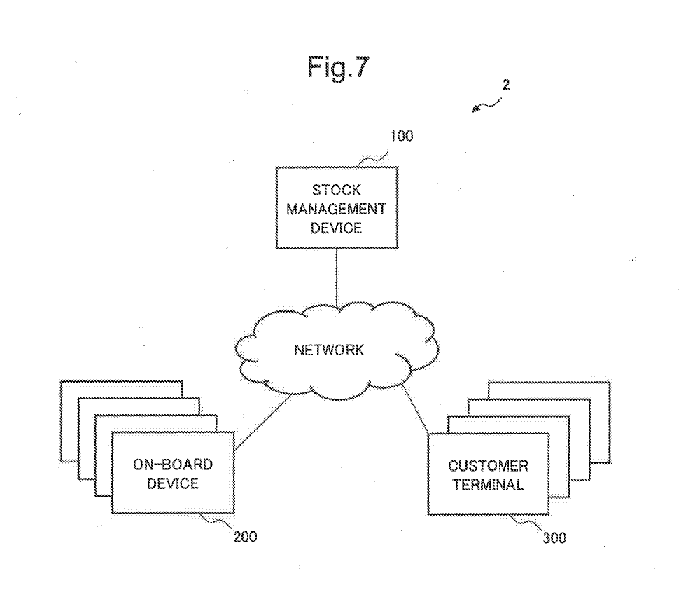

Next, a second example embodiment of the present disclosure based on the aforementioned first example embodiment will be described with reference to drawings. First, FIG. 7 illustrates a configuration example of an item sales system 2 according to the present example embodiment. As illustrated in FIG. 7, the item sales system 2 according to the present example embodiment includes a stock management device 100, a plurality of on-board devices 200, and one or a plurality of customer terminals 300. The stock management device 100 communicates with on-board devices 200 and customer terminals 300 through a network. A customer terminal 300 may be a mobile terminal or may be a desktop terminal.

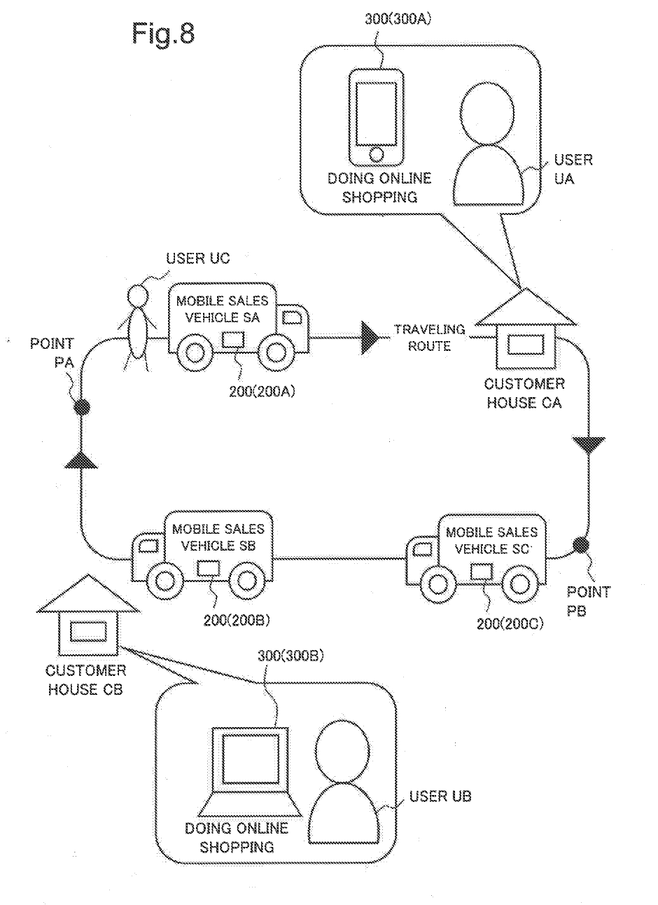

FIG. 8 is a diagram for illustrating a use scene of the item sales system 2 according to the present example embodiment. An on-board device 200 included in the item sales system 2 is a device loaded on each of a plurality of mobile sales vehicles. While three mobile sales vehicles (SA, SB, SC) are included in FIG. 8, a number of mobile sales vehicles has only to be two or more. Further, while an on-board device 200 loaded on the mobile sales vehicle SA is referred to as an on-board device 200A, an on-board device 200 loaded on the mobile sales vehicle SB is referred to as an on-board device 200B, and an on-board device 200 loaded on the mobile sales vehicle SC is referred to as an on-board device 200C, the devices are simply referred to as on-board devices 200 when the devices are not distinguished or are referred to by a generic name.

For example, each of the mobile sales vehicles (SA, SB, SC) is a mobile-type supermarket traveling in accordance with a predetermined traveling route, stopping at a predetermined location, and selling loaded items to a customer. The mobile sales vehicle may also be referred to as a mobile supermarket. Traveling routes according to which a plurality of mobile sales vehicles (SA, SB, SC) travel may be different or partially overlapping with one another.

It is assumed that a user UC is a customer using a mobile sales vehicle, according to the present example embodiment. It is further assumed that a user UA living in a customer house CA is a customer doing online shopping by use of a customer terminal 300A. It is further assumed that a user UB living in a customer house CB is a customer doing online shopping by use of a customer terminal 300B. The customer terminal 300A and the customer terminal 300B are simply referred to as customer terminals 300 when the terminals are not distinguished or referred to by a general name. The customer house CA and the customer house CB may be houses facing roads on the traveling routes of the mobile sales vehicles (SA, SB, SC) or may be houses within a predetermined range from the traveling routes, respectively.

A store providing a service allowing a customer to do online shopping is hereinafter referred to as an online shop.

The item sales system 2 according to the present example embodiment provides both a customer using a mobile sales vehicle and a customer doing online shopping with benefits of using the respective means, by the stock management device 100 communicating with an on-board device 200 and a customer terminal 300.

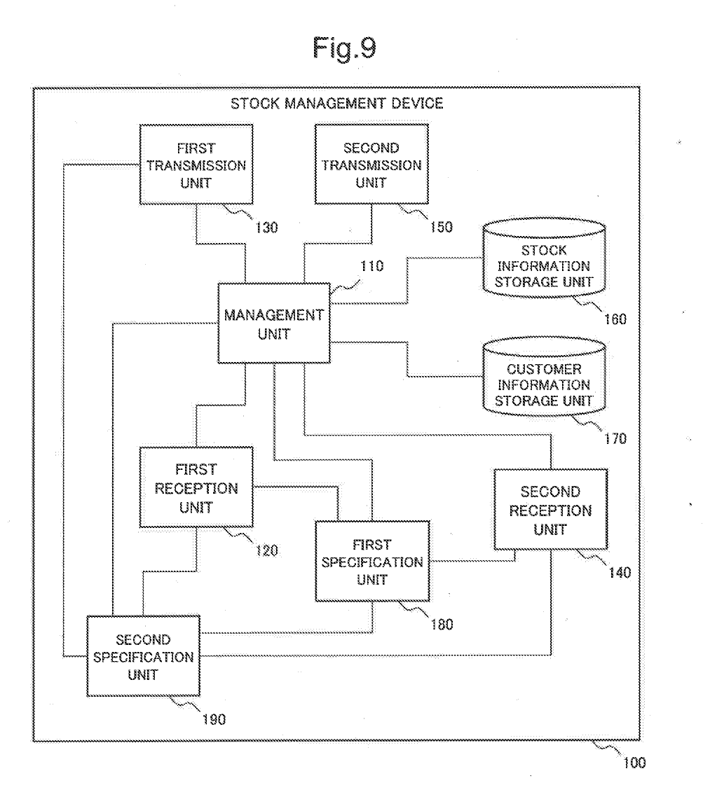

Next, a function of each device in the item sales system 2 according to the present example embodiment will be described in detail. FIG. 9 is a functional block diagram illustrating a functional configuration example of the stock management device 100 in the item sales system 2 according to the present example embodiment. As illustrated in FIG. 9, the stock management device 100 includes a management unit 110, a first reception unit 120, a first transmission unit 130, a second reception unit 140, a first transmission unit 140, a second transmission unit 150, a stock information storage unit 160, a customer information storage unit 170, a first specification unit 180, and a second specification unit 190.

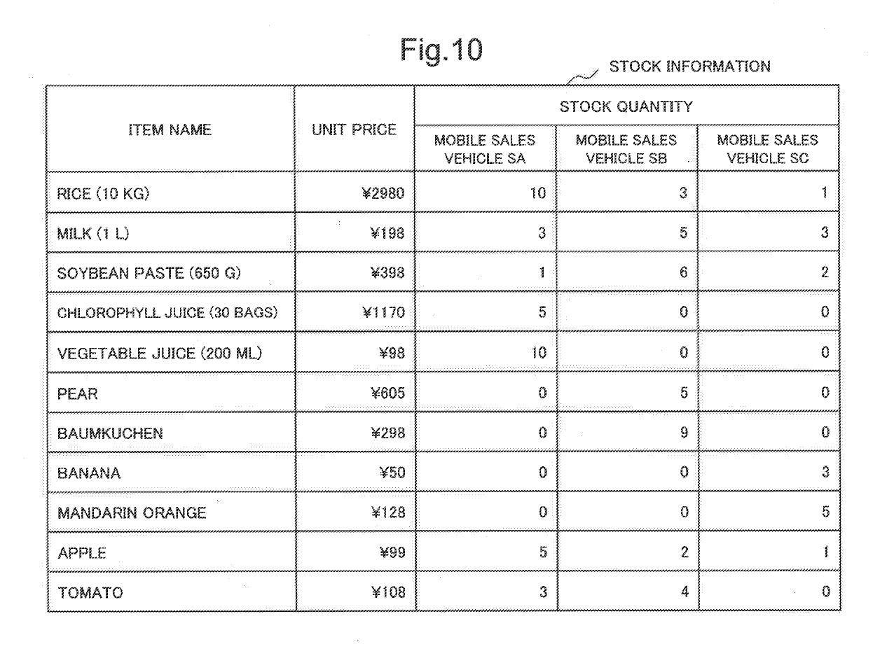

The stock information storage unit 160 stores stock information being information indicating stock of items in stock held by each of a plurality of mobile sales vehicles. The stock information stored by the stock information storage unit 160 will be described with reference to FIG. 10. FIG. 10 is a diagram illustrating an example of stock information stored by the stock information storage unit 160 according to the present example embodiment. The stock information includes at least an item name being information for identifying an item held by each of a plurality of mobile sales vehicles, and a quantity of an item represented by the item name for each mobile sales vehicle. The stock information may include a unit price, as illustrated in FIG. 10. Information included in the stock information is not limited to the above.

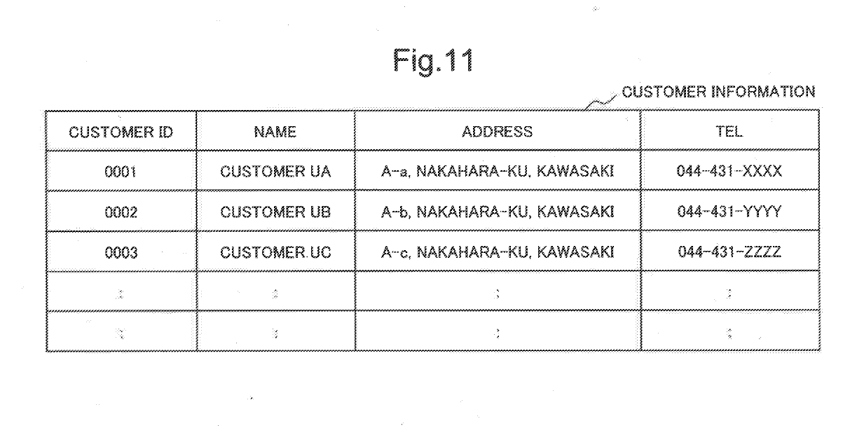

The customer information storage unit 170 stores customer information indicating information about a customer using a mobile sales vehicle and/or an online shop. The customer information stored by the customer information storage unit 170 will be described with reference to FIG. 11. FIG. 11 is a diagram illustrating an example of customer information stored by the customer information storage unit 170 according to the present example embodiment. The customer information includes a customer IDentifier (ID) for identifying a customer, a name of the customer, an address of the customer, and a telephone number of the customer. The customer information is not limited to the above and may include other information. Further, the customer information has only to include information by which a delivery address of an item can be identified. Further, for example, the customer information may include authentication information used for logging into an online shop. The customer information may be pre-registered when a service provided by the item sales system 2 is used. The registration method of the customer information is not particularly limited.

The stock information storage unit 160 and the customer information storage unit 170 may be implemented as separate storage units or may be implemented as the same storage unit. Further, the stock information storage unit 160 and the customer information storage unit 170 may be implemented as a storage device separate from the stock management device 100. Further, the stock information storage unit 160 and the customer information storage unit 170 may store stock information and customer information as databases, respectively.

The first reception unit 120 corresponds to the first reception unit 12 according to the first example embodiment. The first reception unit 120 receives from each of a plurality of mobile sales vehicles sales information indicating an item sold at its storefront. The sales information includes at least information (for example, an item name and an item identifier) for identifying an item sold at the storefront of the mobile sales vehicle and a quantity of the item. It is assumed below that the information for identifying an item is an item name. The first reception unit 120 provides the received sales information to the management unit 110 along with information (referred to as mobile sales vehicle information) indicating a mobile sales vehicle loaded with an on-board device 200 being a source of the sales information. The mobile sales vehicle information may be an identifier for identifying a mobile sales vehicle, a license plate number of the mobile sales vehicle, a vehicle identification number of the mobile sales vehicle, a model name of the mobile sales vehicle, or the like.

Further, the first reception unit 120 receives, from each of a plurality of mobile sales vehicles, current position information indicating a current position of each of the mobile sales vehicles. The first reception unit 120 provides the first specification unit 180 with the received current position information along with mobile sales vehicle information indicating a mobile sales vehicle loaded with an on-board device 200 transmitting the current position information.

The second reception unit 140 corresponds to the second reception unit 14 according to the first example embodiment. The second reception unit 140 receives order information from a customer terminal 300. Order information includes information about an item ordered based on stock information transmitted to a customer terminal 300 by the first transmission unit 130 to be described later. Order information includes information for identifying a customer ordering an item, information (for example, an item name and an item identifier) for identifying the ordered item, the item being included in stock information managed by the management unit 110, and a quantity of the item. Additionally, order information according to the present example embodiment includes information indicating a mobile sales vehicle being to deliver each of the items. The second reception unit 140 provides the received order information to the management unit 110.

Further, the second reception unit 140 receives delivery address information indicating a delivery address designated by a customer. Delivery address information has only to be information that can tell a position of a delivery address, and a form of delivery address information is not particularly limited. For example, when a delivery address is a customer address registered in the customer information storage unit 170, the second reception unit 140 may receive a customer ID by which a delivery address can be specified, as delivery address information. When not receiving an instruction about a delivery address from a customer terminal 300, for example, the second reception unit 140 may determine the aforementioned customer ID being transmitted when online shopping is used to be delivery address information. The second reception unit 140 provides the received delivery address information along with information for specifying a customer terminal 300 to the first specification unit 180 and the second specification unit 190.

Further, when desired delivery time information is transmitted from a customer terminal 300, the second reception unit 140 receives the information indicating the desired delivery time. A desired delivery time is a time at which a customer desires an item to be delivered. A desired delivery time may represent a time period such as from M o'clock to N o'clock. The second reception unit 140 provides the first specification unit 180 with the received information indicating the desired delivery time along with information for specifying the customer terminal 300.

Further, the second reception unit 140 receives a transmission request of information about a mobile sales vehicle being to deliver the item ordered based on stock information by a customer. The second reception unit 140 provides the received transmission request to the second specification unit 190. The transmission request includes at least information (for example, an item name and an item identifier) for identifying an item and a quantity of the item.

The management unit 110 corresponds to the management unit 11 according to the first example embodiment. The management unit 110 manages stock information stored in the stock information storage unit 160. Further, the management unit 110 manages customer information stored in the customer information storage unit 170. Further, the management unit 110 may manage sales information and order information. The sales information and the order information may be stored and managed in a storage unit in the stock management device 100.

Information about stock items loaded on a mobile sales vehicle before each of a plurality of mobile sales vehicles starts mobile sale and also before the items becoming purchasable on an online shopping is registered in the stock information managed by the management unit 110. Then, the management unit 110 updates the stock information every time an item is purchased by mobile sale, every time an item is purchased by online shopping, and every time an item is carried in.

Further, the management unit 110 acquires, from the stock information storage unit 160, stock information to be transmitted to a customer terminal 300 and provides the acquired stock information to the first transmission unit 130. At this time, the stock information acquired by the management unit 110 may be stock information about stock held by each of the mobile sales vehicles allowing a customer to purchase the items on an online shop at present, or may be stock information about stock held by mobile sales vehicles positioned within a predetermined range from a customer terminal 300, based on a position of the customer terminal 300. The mobile sales vehicle allowing a customer to purchase items on an online shop at present refers to, for example, a mobile sales vehicle capable of selling items on a luggage carrier at present, such as a mobile sales vehicle not being back in a garage, a mobile sales vehicle not all of items running out of stock, or a mobile sales vehicle not ending sale (not on the way back to a garage). Further, the stock information acquired by the management unit 110 may be, for example, stock information about stock held by a mobile sales vehicle positioned within a predetermined range from a delivery address when the delivery address is designated by a customer terminal 300. Further, the stock information acquired by the management unit 110 may be stock information about stock held by a mobile sales vehicle predesignated by a customer.

Further, when receiving information indicating a mobile sales vehicle from the first specification unit 180, the management unit 110 acquires stock information about stock held by the mobile sales vehicle from the stock information storage unit 160 and provides the acquired stock information to the first transmission unit 130.

Further, the management unit 110 updates stock information, based on at least one of sales information and order information. For example, when sales information is transmitted from the on-board device 200 on the mobile sales vehicle SA, the management unit 110 updates stock information about stock held by the mobile sales vehicle SA, based on the sales information. Further, for example, when a mobile sales vehicle holding an item included in order information is the mobile sales vehicle SA, the management unit 110 updates stock information about stock held by the mobile sales vehicle SA, based on the order information.

Further, the management unit 110 provides the second transmission unit 150 with order information received by the second reception unit 140 along with information indicating a mobile sales vehicle being to deliver an item included in the order information.

Further, when an item of which quantity in stock becomes zero by updating stock information exists, the management unit 110 may transmit, to a mobile sales vehicle holding the item the stock quantity of which is zero sellout information indicating that the item held by the mobile sales vehicle is sold out.

The first specification unit 180 corresponds to the first specification unit 16 according to the first example embodiment. When the second reception unit 140 receives desired delivery time information from a customer terminal, the first specification unit 180 receives the information indicating the desired delivery time from the second reception unit 140. Further, the first specification unit 180 receives current position information from the first reception unit 120. Further, the first specification unit 180 receives delivery address information from the second reception unit 140.

Based on current positions of the mobile sales vehicles each indicated by each pieces of current position information and a position of a delivery address indicated by delivery address information, the first specification unit 180 specifies a mobile sales vehicle capable of delivering items to the delivery address by the desired delivery time. The first specification unit 180 provides information indicating the specified mobile sales vehicle to the second specification unit 190 and the management unit 110.

The second specification unit 190 receives current position information from the first reception unit 120. Further, the second specification unit 190 receives, from the second reception unit 140, delivery address information and a transmission request of information about a mobile sales vehicle being to deliver the item ordered by a customer. The second specification unit 190 receives, from the first specification unit 180, information indicating a mobile sales vehicle specified by the first specification unit 180. Out of mobile sales vehicles holding the ordered item, the second specification unit 190 specifies a mobile sales vehicle delivering the item fastest to a delivery address, based on current positions of the mobile sales vehicles and a position of the delivery address, for each of the items. The mobile sales vehicle holding the ordered item is a mobile sales vehicle specified by the first specification unit 180. The second specification unit 190 provides information indicating a mobile sales vehicle specified for each of the items to the first transmission unit 130.

The first transmission unit 130 corresponds to the first transmission unit 13 according to the first example embodiment. The first transmission unit 130 receives stock information from the management unit 110. The first transmission unit 130 transmits the stock information to a customer terminal 300. When, for example, a browser is activated by a customer terminal 300, the first transmission unit 130 may generate a screen including stock information and transmit the generated screen to the customer terminal 300. Further, when, for example, an application is activated by a customer terminal 300, the first transmission unit 130 may transmit information including stock information to the customer terminal 300 in such a way that the application can display a screen including the stock information. When a customer terminal 300 can display a screen including stock information, the first transmission unit 130 may transmit stock information itself acquired by the management unit 110. It is preferable that a timing when the first transmission unit 130 transmits stock information to a customer terminal 300 be after detecting an operation of a customer for purchasing an item by use of the customer terminal 300. Detecting an operation of a customer for purchasing an item by use of a customer terminal 300 includes, for example, detecting, by a customer inputting login information to a customer terminal 300 for logging into an online shop, reception of the login information from the customer terminal 300 by the stock management device 100. Consequently, the customer using the customer terminal 300 can confirm stock information at a timing of logging into the online shop.

Further, the first transmission unit 130 may further transmit the updated stock information to a customer terminal 300 every time stock information is updated. Consequently, a customer using the customer terminal 300 can confirm latest stock information at updating.

Further, when receiving, from the management unit 110, stock information of a mobile sales vehicle specified by the first specification unit 180 after transmitting stock information, the first transmission unit 130 transmits the stock information of the mobile sales vehicle to the customer terminal 300. When the transmitted stock information is stock information for each mobile sales vehicle, the first transmission unit 130 may receive, from the management unit 110, information indicating the mobile sales vehicle specified by the first specification unit 180 and transmit the information indicating the mobile sales vehicle to the customer terminal 300.

Further, when receiving information for each of the items indicating a mobile sales vehicle delivering each of the items from the second specification unit 190, the first transmission unit 130 transmits information indicating the mobile sales vehicle for each of the items to the customer terminal 300. The identification unit 130 may transmit, to the customer terminal 300, information for specifying a mobile sales vehicle for each of the items or may transmit, to the customer terminal 300, information telling a number of mobile sales vehicles (for example, information being a “first mobile sales vehicle”).

The second transmission unit 150 corresponds to the second transmission unit 15 according to the first example embodiment. The second transmission unit 150 transmits order information along with delivery address information to a mobile sales vehicle holding an ordered item included in the order information.

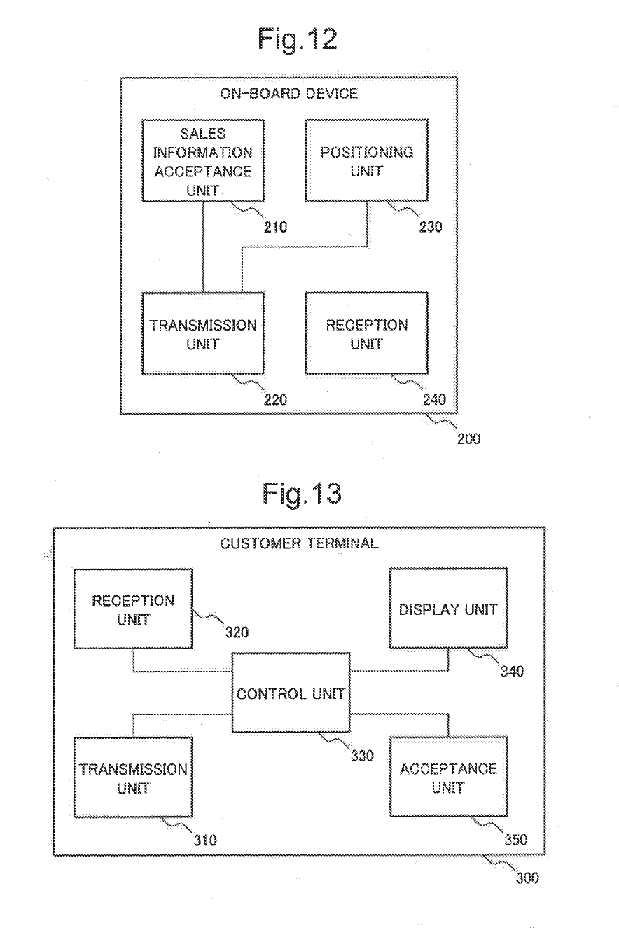

Next, a functional configuration of an on-board device 200 will be described with reference to FIG. 12. FIG. 12 is a functional block diagram illustrating a functional configuration example of an on-board device 200 in the item sales system 2 according to the present example embodiment. The on-board device 200 includes a sales information acceptance unit 210, a transmission unit 220, a positioning unit 230, and a reception unit 240.

The sales information acceptance unit 210 accepts sales information including an item name of an item sold by a mobile sale (an item purchased by a customer) of a mobile sales vehicle loaded with the on-board device 200, and a quantity of the item. For example, the sales information acceptance unit 210 is implemented with a point of sales (POS) register. The sales information acceptance unit 210 provides the accepted sales information to the transmission unit 220.

For example, the positioning unit 230 receives positional information by use of the Global Positioning System (GPS), and from the received positional information, measures a current position of each of the mobile sales vehicles loaded with the on-board device 200. A means used for measurement of a current position is not limited to the GPS. The positioning unit 230 may measure a current position by use of other information. The positioning unit 230 provides information (current position information) indicating a current position being a positioning result to the transmission unit 220.

When receiving sales information from the sales information acceptance unit 210, the transmission unit 220 transmits the sales information to the stock management device 100. Further, when receiving current position information from the positioning unit 230, the transmission unit 220 transmits the current position information to the stock management device 100.

The reception unit 240 receives order information transmitted from the stock management device 100. Consequently, based on the order information, a mobile sales vehicle loaded with the on-board device 200 receiving the order information can deliver an ordered item to a delivery address indicated by delivery address information received with the order information.

Further, when sellout information is transmitted from the stock management device 100, the reception unit 240 may receive the sellout information. Consequently, a driver of a mobile sales vehicle loaded with the on-board device 200 or a customer using the mobile sales vehicle can understand that an item indicated by the sellout information is sold out.

Next, a functional configuration of a customer terminal 300 will be described with reference to FIG. 13. FIG. 13 is a functional block diagram illustrating a functional configuration example of a customer terminal 300 in the item sales system 2 according to the present example embodiment. As illustrated in FIG. 13, the customer terminal 300 includes a transmission unit 310, a reception unit 320, a control unit (display control unit) 330, a display unit 340, and an acceptance unit 350.

The reception unit 320 corresponds to the reception unit 32 according to the first example embodiment. The reception unit 320 receives stock information from the stock management device 100. The stock information has only to include information required for displaying information about a stock in a mobile sales vehicle on the display unit 340 and may be, for example, stock information itself stored in the stock information storage unit 160, part of the stock information, or processed stock information. The reception unit 320 provides the received stock information to the control unit 330.

Further, the reception unit 320 receives stock information about stock held by a mobile sales vehicle capable of delivering items to a delivery address by a desired delivery time, or information indicating the mobile sales vehicle. The reception unit 320 provides the received stock information or the received information indicating the mobile sales vehicle to the control unit 330. Further, the reception unit 320 receives, from the stock management device 100, information indicating a mobile sales vehicle capable of delivering items fastest, for each of the items designated by a customer. Then, the reception unit 320 provides the received information to the control unit 330.

The display unit 340 displays a screen in accordance with an instruction by the control unit 330. For example, the display unit 340 is implemented with a liquid crystal display. The display unit 340 may be implemented with a display device separate from the customer terminal 300.

The acceptance unit 350 accepts an instruction from a user using the customer terminal 300. For example, the acceptance unit 350 accepts an instruction from a user input through an input device such as a mouse or a keyboard. The acceptance unit 350 provides the accepted instruction to the control unit 330.

The acceptance unit 350 and the display unit 340 may be integrally formed as a touch panel.

The control unit 330 corresponds to the display control unit 33 according to the first example embodiment. The control unit 330 causes the display unit 340 to display a screen based on stock information received by the reception unit 320. Further, the control unit 330 causes the display unit 340 to display delivery times of items in a selectable manner. The selected delivery time of the item is a time at which a customer desires the item to be delivered and therefore is referred to as a desired delivery time. The control unit 330 provides the transmission unit 310 with information indicating the selected desired delivery time specified in accordance with an instruction accepted by the acceptance unit 350.

Further, the control unit 330 provides the transmission unit 310 with order information including information about an item ordered by a customer.

Further, when receiving, from the reception unit 320, information indicating a mobile sales vehicle capable of delivering items fastest, for each of the items designated by a customer, the control unit 330 causes the display unit 340 to display the received information.

The transmission unit 310 corresponds to the transmission unit 31 according to the first example embodiment. When receiving desired delivery time information from the control unit 330, the transmission unit 310 transmits information indicating the desired delivery time to the stock management device 100. Further, the transmission unit 310 transmits delivery address information indicating a delivery address of an item. The delivery address information may be input by a customer.

Further, when receiving order information from the control unit 330, the transmission unit 310 transmits the order information to the stock management device 100.

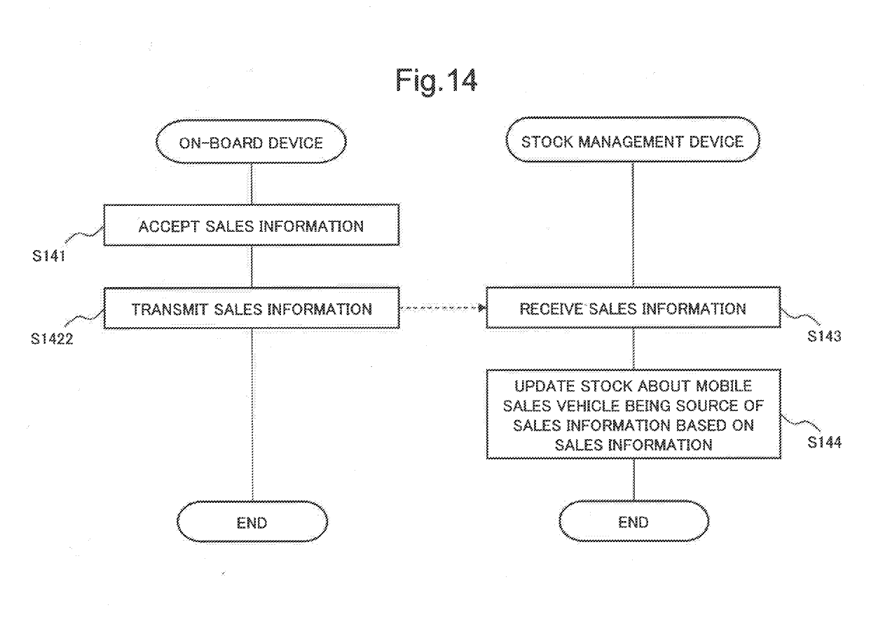

Next, processing of updating stock information, based on sales information, in the item sales system 2 will be described with reference to FIG. 14. FIG. 14 is a flowchart illustrating an example of a flow of the processing of updating stock information, based on sales information, in the item sales system 2 according to the present example embodiment.

It is assumed in FIG. 14 that the management unit 110 in the stock management device 100 manages stock information about stock of an item held by a plurality of mobile sales vehicles, for each mobile sales vehicle. Further, in FIG. 14, processing by an on-board device 200 is described on the left and processing by the stock management device 100 on the right; and a broken arrow between the respective processing steps represents a flow of primary information. An information flow is not limited to a direction of an arrow, and for example, an ACK may be transmitted in a direction reverse to the arrow.

First, by a mobile sales vehicle loaded with the on-board device 200 conducting mobile sale, the sales information acceptance unit 210 in the on-board device 200 accepts sales information including an item name of a sold item (an item purchased by a customer) and a quantity of the item (Step S141). Then, the transmission unit 220 transmits the sales information to the stock management device 100 (Step S142).

The first reception unit 120 in the stock management device 100 receives the sales information transmitted from the on-board device 200 (Step S143). The first reception unit 120 provides the sales information to the management unit 110 along with mobile sales vehicle information.

Based on the sales information provided from the first reception unit 120, the management unit 110 updates stock information about stock held by a mobile sales vehicle specified by the mobile sales vehicle information transmitted along with the sales information (Step S144).

The above concludes the processing of updating stock information, based on sales information.

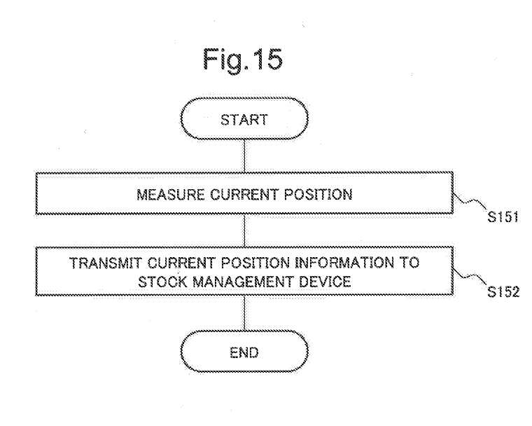

Next, transmission processing of current position information by an on-board device 200 will be described with reference to FIG. 15. FIG. 15 is a flowchart illustrating an example of a flow of the transmission processing of current position information by an on-board device 200 in the item sales system 2 according to the present example embodiment. The processing illustrated in FIG. 15 is performed asynchronously with the processing of updating stock information illustrated in FIG. 14.

As illustrated in FIG. 15, the positioning unit 230 measures a current position (Step S151). The positioning unit 230 provides current position information being the positioning result to the transmission unit 220. Then, the transmission unit 220 transmits the current position information to the stock management device 100 (Step S152).

The above concludes the transmission processing of current position information by an on-board device 200.

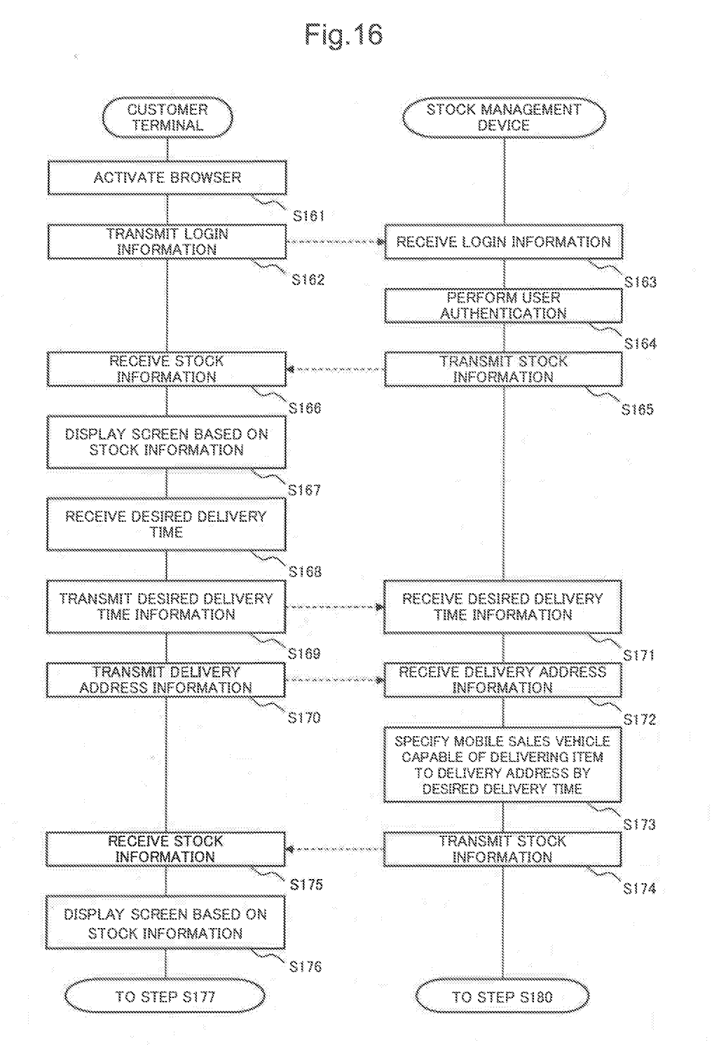

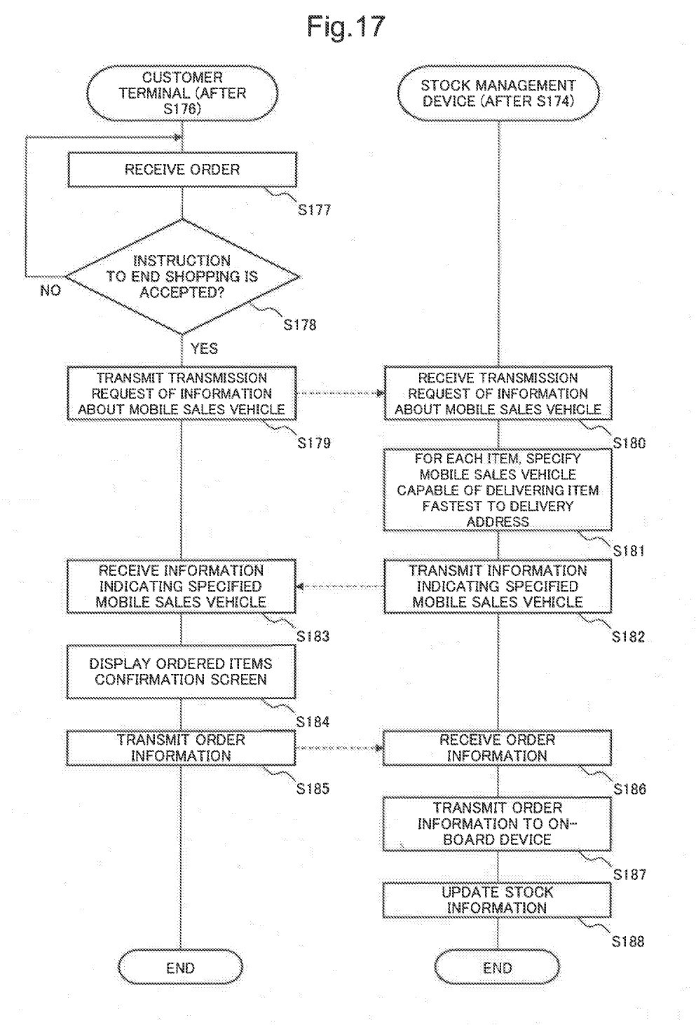

Next, sales processing of an item by online shopping in the item sales system 2 will be described with reference to FIGS. 16 and 17. FIGS. 16 and 17 are flowcharts illustrating an example of a flow of the sales processing of an item by online shopping in the item sales system 2 according to the present example embodiment. The processing illustrated in FIGS. 16 and 17 is performed asynchronously with the processing of updating stock information illustrated in FIG. 14 and the transmission processing of current position information illustrated in FIG. 15.

In FIGS. 16 and 17, processing by a customer terminal 300 is indicated on the left, and processing by the stock management device 100 on the right. Further, a broken arrow between the respective processing steps in FIGS. 16 and 17 represents a flow of primary information. An information flow is not limited to a direction of an arrow, and for example, an ACK may be transmitted in a direction reverse to the arrow. Further, the description in FIGS. 16 and 17 assumes that a customer selects a desired delivery time.

A user (customer) using a customer terminal 300 inputs an instruction to start online shopping into the customer terminal 300, and the acceptance unit 350 accepts a content of the instruction. For example, when an instruction to activate a browser is input in order to do online shopping, the control unit 330 activates the browser (Step S161). For example, when processing accepted by the acceptance unit 350 is an instruction to activate an application for doing online shopping, the control unit 330 activates the application installed on the customer terminal 300.

Then, the transmission unit 310 transmits information required for doing online shopping to the stock management device 100. For example, the transmission unit 310 transmits to the stock management device 100 login information, such as a customer ID and authentication information for logging into an online shop (Step S162). The login information may be input by a customer for each shopping.

When receiving the login information transmitted from the customer terminal 300 (Step S163), the second reception unit 140 in the stock management device 100 transmits the login information to the management unit 110. Then, the management unit 110 refers to the customer information storage unit 170 and performs user authentication (Step S164). The user authentication may use any method, and therefore description is omitted in the present example embodiment.

Subsequently, when the customer is authenticated, the management unit 110 acquires stock information stored in the stock information storage unit 160 and provides the acquired stock information to the first transmission unit 130. The first transmission unit 130 transmits the stock information provided from the management unit 110 to the customer terminal 300 transmitting the login information to the stock management device 100 (Step S165). The first transmission unit 130 may transmit, as the stock information, an item name, a unit price, and a total stock quantity of an item with the item name, or may transmit, as the stock information, an item name, a unit price, and a stock quantity of an item with the item name for each mobile sales vehicle. Unless otherwise specified, it is assumed in the following description that the first transmission unit 130 has transmitted, as the stock information, an item name, a unit price, and a total stock quantity of an item with the item name. A timing of transmission of the stock information by the first transmission unit 130 may be after the stock management device 100 receives a transmission instruction of stock information from the customer terminal subsequently to performing the user authentication. The timing of transmission of the stock information by the first transmission unit 130 has only to be after detection of the customer starting shopping on an online shop by use of the customer terminal 300 (performing an operation for purchasing an item by use of the customer terminal 300) such as after the stock management device 100 receives the aforementioned transmission instruction of stock information. Further, the item sales system 2 may be configured not to perform user authentication.

The reception unit 320 in the customer terminal 300 receives the stock information from the stock management device 100 (Step S166). Subsequently, the control unit 330 causes the display unit 340 to display a screen based on the received stock information (Step S167).

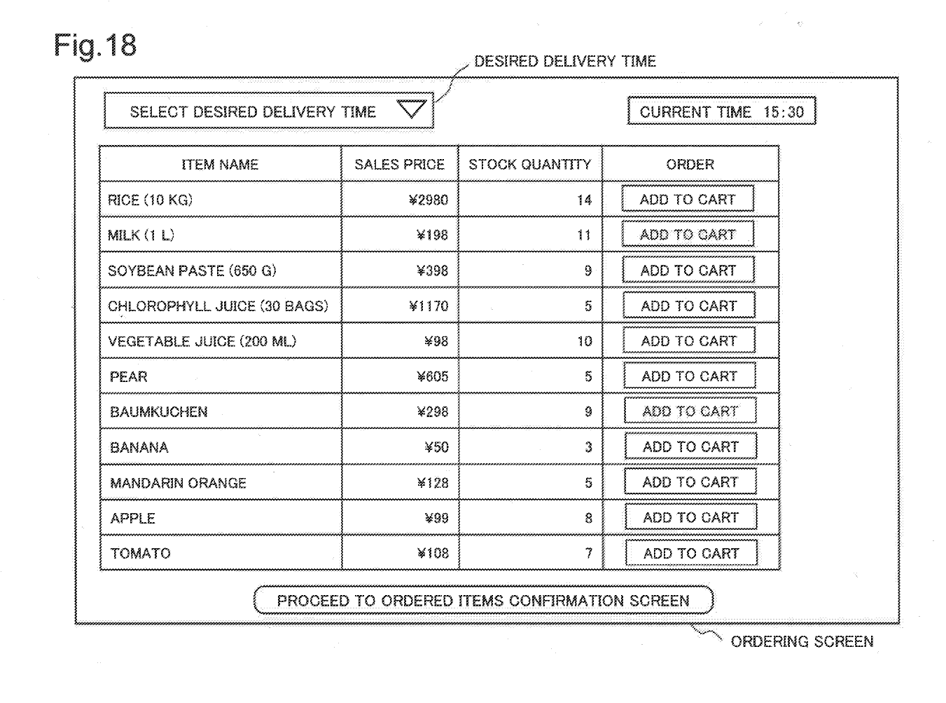

The screen (ordering screen) based on stock information displayed by the display unit 340 will be described with reference to FIG. 18. FIG. 18 is a diagram illustrating an example of an ordering screen displayed by the display unit 340 in a customer terminal 300 according to the present example embodiment. It is assumed in the example in FIG. 18 that the stock information illustrated in FIG. 10 has been transmitted to the customer terminal 300 from the stock management device 100. The ordering screen illustrated in FIG. 18 displays a total stock quantity in the mobile sales vehicles (SA, SB, SC).

An “ADD TO CART” button in FIG. 18 is a button for accepting an instruction to add a relevant item to a cart on an online shop. In accordance with the instruction, the control unit 330 keeps information about the item added to the cart as cart information. The cart information includes information for identifying an item and a quantity of the item.

A “PROCEED TO ORDERED ITEMS CONFIRMATION SCREEN” button in FIG. 18 is a button for transition to a screen for confirming an item ordered by a customer. On the ordered items confirmation screen, a list of items added to the cart is displayed. Details of the ordered items confirmation screen will be described later. While the ordered items confirmation screen will be described as being displayed on a screen separate from the ordering screen in FIG. 18, the ordered items confirmation screen and the ordering screen may be displayed in separate frames on the same browser. Display forms of the ordering screen and the ordered items confirmation screen are not particularly limited.

Further, the ordering screen illustrated in FIG. 18 displays a plurality of desired delivery times in a selectable manner. A customer can select a delivery time at which the customer desires the item to be delivered, out of the plurality of desired delivery times displayed in a selectable manner. Information indicating the selectable delivery times may be previously stored in the customer terminal 300 or may be transmitted from the stock management device 100 along with stock information. Further, while desired delivery times are displayed in a pull-down menu in FIG. 18, the control unit 330 may cause to display desired delivery times with radio buttons or may cause to display the desired delivery times with checkboxes.

When the acceptance unit 350 accepts a selection of a delivery time (Step S168), the control unit 330 provides information indicating the selected desired delivery time to the transmission unit 310. Then, the transmission unit 310 transmits the information indicating the desired delivery time to the stock management device 100 (Step S169). Further, the transmission unit 310 transmits delivery address information indicating a delivery address of an item to the stock management device 100 (Step S170). Step S170 may be performed before Step S169 or may be performed at a time with Step S169.

The second reception unit 140 in the stock management device 100 receives the information indicating the desired delivery time from the customer terminal 300 (Step S171). Further, the second reception unit 140 receives the delivery address information from the customer terminal 300 (Step S172).

Then, based on current positions of the mobile sales vehicles each indicated by each pieces of current position information, and a position of the delivery address indicated by the delivery address information, the first specification unit 180 specifies a mobile sales vehicle capable of delivering items to the delivery address by the desired delivery time (Step S173).

Then, the first transmission unit 130 transmits stock information of the mobile sales vehicle specified in Step S173 to the customer terminal 300 (Step S174). When the stock information transmitted to the customer terminal 300 by the first transmission unit 130 in Step S165 is stock information for each mobile sales vehicle, the first transmission unit 130 may transmit information indicating the specified mobile sales vehicle in place of the stock information of the specified mobile sales vehicle.

Then, the reception unit 320 in the customer terminal 300 receives the stock information from the stock management device 100 (Step S175). Then, the control unit 330 causes the display unit 340 to display a screen based on the stock information (Step S176). When the reception unit 320 receives each stock information of each mobile sales vehicle in Step S166, the reception unit 320 may receive information indicating the specified mobile sales vehicle in place of the stock information of the specified mobile sales vehicle. Consequently, the control unit 330 can display, on the display unit 340, only stock information of a mobile sales vehicle indicated by the information indicating the specified mobile sales vehicle in the stock information which the control unit 330 causes the display unit 340 to display in Step 167.

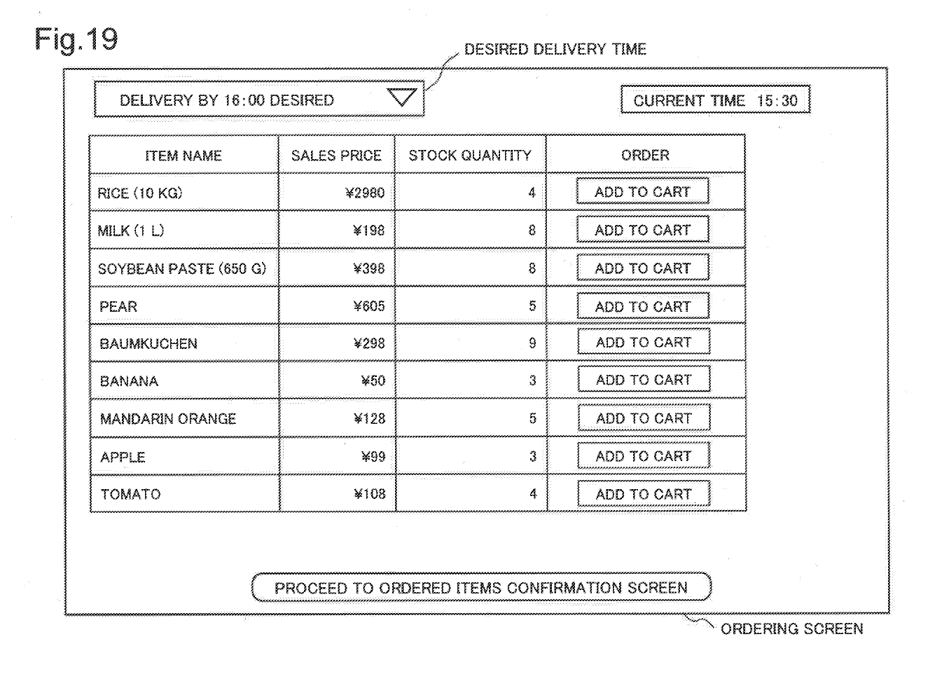

FIG. 19 is a diagram illustrating another example of an ordering screen displayed by the display unit 340 in the customer terminal 300 after selection of a desired delivery time. It is assumed in FIG. 19 that, by a customer selecting the desired delivery time, the first specification unit 180 specifies that mobile sales vehicles capable of delivering items to a delivery address by the desired delivery time are the mobile sales vehicle SB and the mobile sales vehicle SC. Consequently, the control unit 330 causes the display unit 340 to display only stock information of the mobile sales vehicle SB and the mobile sales vehicle SC in the stock information illustrated in FIG. 10.

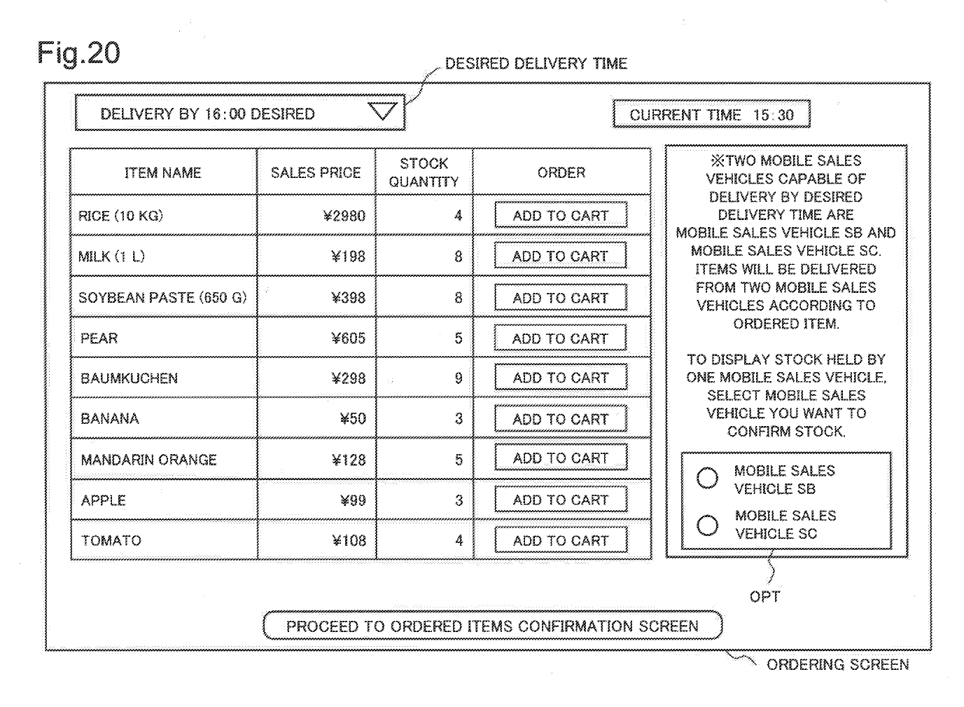

The control unit 330 may further display a component for allowing selection of a mobile sales vehicle on the ordering screen, as illustrated in FIG. 20. FIG. 20 is a diagram illustrating an example of an ordering screen when a selection component OPT for allowing selection of a mobile sales vehicle is displayed on the ordering screen in FIG. 19. As illustrated in FIG. 20, the ordering screen displays the selection component OPT for selecting a mobile sales vehicle. For example, when a customer selects the “mobile sales vehicle SB” in the selection component OPT, the control unit 330 gets only stock information of the mobile sales vehicle SB displayed on the ordering screen. When receiving stock information for each mobile sales vehicle from the stock management device 100, the control unit 330 may control the display unit 340 to display stock information of a selected mobile sales vehicle, based on the selection. Further, when collectively receiving, from the stock management device 100, stock information about stock held by mobile sales vehicles capable of delivering items to a delivery address by a desired delivery time, the control unit 330 may transmit a transmission request of stock information, based on the selection, to the stock management device 100. Then, the control unit 330 may control the display unit 340 to display stock information received as a response to the transmission request.

Processing in and after Step S177 will be described with reference to FIG. 17.

Subsequently, the customer orders an item by use of the screen (ordering screen) displayed based on the stock information. For example, when the customer depresses an “ADD TO CART” button illustrated in FIG. 19, the customer terminal 300 receives an order of an item by the customer, by acceptance of the depression of the button by the acceptance unit 350 (Step S177). Subsequently, for example, when a “PROCEED TO ORDER CONTENT CONFIRMATION SCREEN” button illustrated in FIG. 19 is depressed by the customer, the customer terminal 300 determines that an instruction to end the shopping is accepted, by acceptance of the depression of the button by the acceptance unit 350 (YES in Step S178). The customer terminal 300 repeats Steps S177 and S178 until the acceptance unit 350 accepts an instruction to end the shopping.

Subsequently, the control unit 330 generates a transmission request of information about a mobile sales vehicle delivering the item added to the cart (the item ordered by the customer, based on the stock information), the item being kept as cart information. It is assumed that the transmission request includes an item name indicating the item added to the cart and a quantity of the item. Then, the transmission unit 310 transmits the transmission request to the stock management device 100 (Step S179).

The second reception unit 140 receives the transmission request requesting transmission of information about a mobile sales vehicle delivering the item ordered by the customer (Step S180). For each of the items, the second specification unit 190 specifies a mobile sales vehicle delivering the item fastest to the delivery address, based on current positions of the mobile sales vehicles and the position of the delivery address, out of the mobile sales vehicles specified by the first specification unit 180 (Step S181). Then, as a response to the aforementioned transmission request, the first transmission unit 130 transmits information indicating the mobile sales vehicle specified in Step S181 for each of the items to the customer terminal 300 (Step S182).

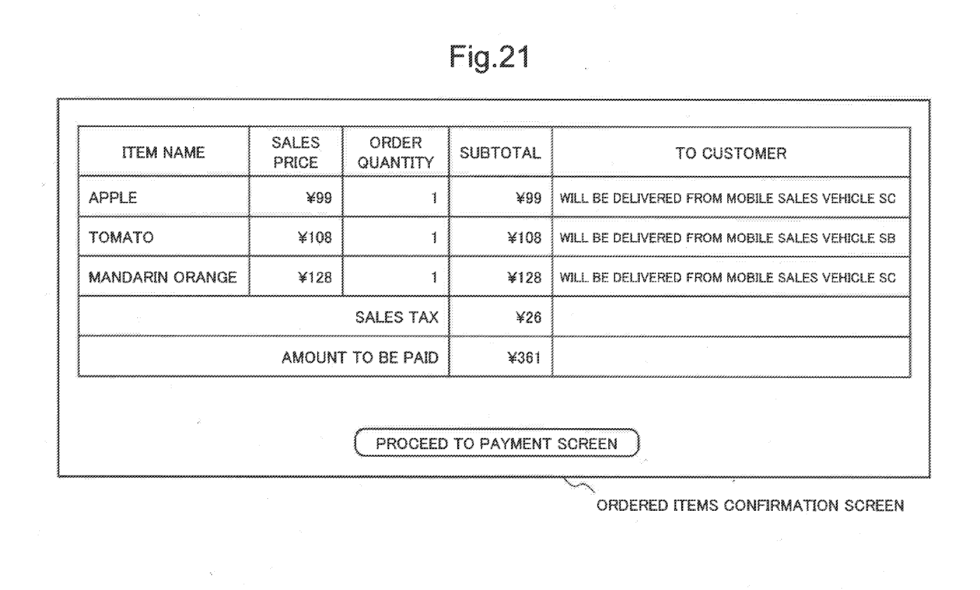

Then, the reception unit 320 receives, from the stock management device 100, the information indicating the mobile sales vehicle for each of the items (Step S183). Subsequently, the control unit 330 causes the display unit 340 to display an ordered items confirmation screen (Step S184). The ordered items confirmation screen which the control unit 330 causes the display unit 340 to display in Step S179 will be described with reference to FIG. 21. For example, it is assumed that a customer adds “APPLE,” “TOMATO,” and “MANDARIN ORANGE” to the cart on the ordering screen illustrated in FIG. 19. The control unit 330 displays the ordered items confirmation screen, based on kept cart information. At this time, the control unit 330 gets information indicating a mobile sales vehicle delivering each of the items displayed, based on information indicating the mobile sales vehicle for each of the items, the information being received by the reception unit 320. For example, since “MANDARIN ORANGE” is held only by the mobile sales vehicle SC, information indicating that the mobile sales vehicle SC performs delivery is displayed as illustrated in FIG. 21. Similarly, since “TOMATO” is held only by the mobile sales vehicle SB, information indicating that the mobile sales vehicle SB performs delivery is displayed. Further, “APPLE” is held by both the mobile sales vehicle SB and the mobile sales vehicle SC, as illustrated in FIG. 10. When the second specification unit 190 specifies that a mobile sales vehicle delivering the “APPLE” faster to the delivery address is the mobile sales vehicle SC, the reception unit 320 receives information indicating the mobile sales vehicle SC as information indicating a mobile sales vehicle related to “APPLE.” Consequently, the control unit 330 can get the information indicating that a mobile sales vehicle delivering “APPLE” faster to the delivery address is the mobile sales vehicle SC displayed on the screen. Further, the control unit 330 may get information telling a number of mobile sales vehicles (for example, information being a “first mobile sales vehicle”) displayed on the screen, in place of or in addition to information specifying the mobile sales vehicles.

A “PROCEED TO PAYMENT SCREEN” button in FIG. 21 is a button for transitioning to a screen for making payment. A payment method can be selected on the payment screen. The payment method is not particularly limited, and therefore description is omitted in the present example embodiment. When an instruction to make payment is input, the acceptance unit 350 accepts the instruction. Then, in accordance with the instruction to make payment, the control unit 330 provides the transmission unit 310 with information kept as cart information (information about an item included in the ordered items confirmation screen), information for identifying a customer, and information indicating a mobile sales vehicle delivering each of the items, as order information. Subsequently, the transmission unit 310 transmits the order information to the stock management device 100 (Step S185).

The second reception unit 140 in the stock management device 100 receives the order information (Step S186). Then, based on the order information received by the second reception unit 140, the second transmission unit 150 transmits the order information to a mobile sales vehicle being to deliver each of the items included in the order information (Step S187). For example, the second transmission unit 150 transmits, to the on-board device 200B on the mobile sales vehicle SB, order information including information about an item to be delivered by the mobile sales vehicle SB (“TOMATO” in the case of the example illustrated in FIG. 21), from information about every items included in the order information. Further, for example, the second transmission unit 150 transmits, to the on-board device 200C on the mobile sales vehicle SC, order information including information about an item delivered by the mobile sales vehicle SC (“MANDARIN ORANGE” and “APPLE” in the case of the example in FIG. 21), from the information about every items included in the order information.

Further, the management unit 110 updates the stock information based on the order information (Step S188). Step S188 may be performed before Step S187 or may be performed at a time with Step S188.

Since the reception unit 240 in the on-board device 200 receives the order information transmitted from the stock management device 100 by Step S187 being performed, a mobile sales vehicle loaded with the on-board device 200 can deliver the item to the customer, based on the order information.

The above concludes the sales processing of an item by online shopping, by the item sales system 2.

As described above, the management unit 110 in the stock management device 100 in the item sales system 2 according to the present example embodiment manages stock information about stock of an item held by each of a plurality of mobile sales vehicles. Further, the first reception unit 120 receives sales information indicating an item sold at the mobile sales vehicle from an on-board device 200 loaded on each of the plurality of mobile sales vehicles. Further, the second reception unit 140 receives, from a customer terminal 300, order information including information about an item ordered based on stock information transmitted to the customer terminal 300. Additionally, the second transmission unit 150 transmits order information to an on-board device 200 loaded on a mobile sales vehicle holding an ordered item included in the order information. Consequently, a mobile sales vehicle loaded with an on-board device 200 receiving the order information can deliver the ordered item to a customer ordering the item.

Furthermore, based on a current position of each of the mobile sales vehicles and a position of a delivery address, the first specification unit 180 in the stock management device 100 specifies a mobile sales vehicle capable of delivering items to the delivery address by a desired delivery time. Then, the first transmission unit 130 transmits stock information of the specified mobile sales vehicle. Consequently, a customer doing online shopping by use of a customer terminal 300 can confirm stock information of a mobile sales vehicle capable of delivering items by a desired time. Accordingly, the customer can do online shopping while understanding whether or not items of which the customer desires to purchase can be delivered by the desired time.

Accordingly, the item sales system 2 including the stock management device 100 according to the present example embodiment capable of bringing both a benefit of online shopping and a benefit by using a mobile sales vehicle to a customer purchasing an item by online shopping, and further capable of providing the customer with information of an item that can be delivered by a time desired by the customer.

The second reception unit 140 further receives, from a customer terminal 300, a transmission request of information about a mobile sales vehicle delivering the item ordered based on stock information. Then, based on a current position of the mobile sales vehicles and a position of a delivery address, the second specification unit 190 specifies a mobile sales vehicle delivering the ordered item fastest to the delivery address, out of the mobile sales vehicles holding the item. Consequently, a customer using the customer terminal 300 receiving information indicating the specified mobile sales vehicle can readily confirm which item is delivered from which mobile sales vehicle.

The second specification unit 190 may specify a mobile sales vehicle delivering an item fastest to a delivery address in consideration of information indicating whether or not a mobile sales vehicle is open for business, a storefront sales schedule, scheduled traveling route information, or the like. A mobile sales vehicle being open for business represents a state in which a mobile sales vehicle stops at a predetermined location, a luggage carrier is opened, and an item loaded on the mobile sales vehicle is ready to be sold to a customer. For example, the information indicating whether or not a mobile sales vehicle is open for business may be based on a signal indicating that a luggage carrier of the mobile sales vehicle is opened, the signal being transmitted from an on-board device 200 to the stock management device 100. Further, a storefront sales schedule indicates where and when a mobile sales vehicle is scheduled to perform mobile sale. The storefront sales schedule may be stored inside the stock management device 100 or may be transmitted from an on-board device 200. Further, scheduled traveling route information is information indicating a route on which a mobile sales vehicle is scheduled to travel. The scheduled traveling route information may be stored inside the stock management device 100 or may be transmitted from an on-board device 200. Further, the second specification unit 190 may specify a mobile sales vehicle delivering an item fastest to a delivery address in consideration of a traveling direction of a mobile sales vehicle, road information at that time, and the like. The traveling direction of a mobile sales vehicle and the road information may be transmitted from an on-board device 200. The road information may be information indicating a traffic jam or information preset to a road such as one-way traffic. Further, the road information may be transmitted from an external server managing road information.

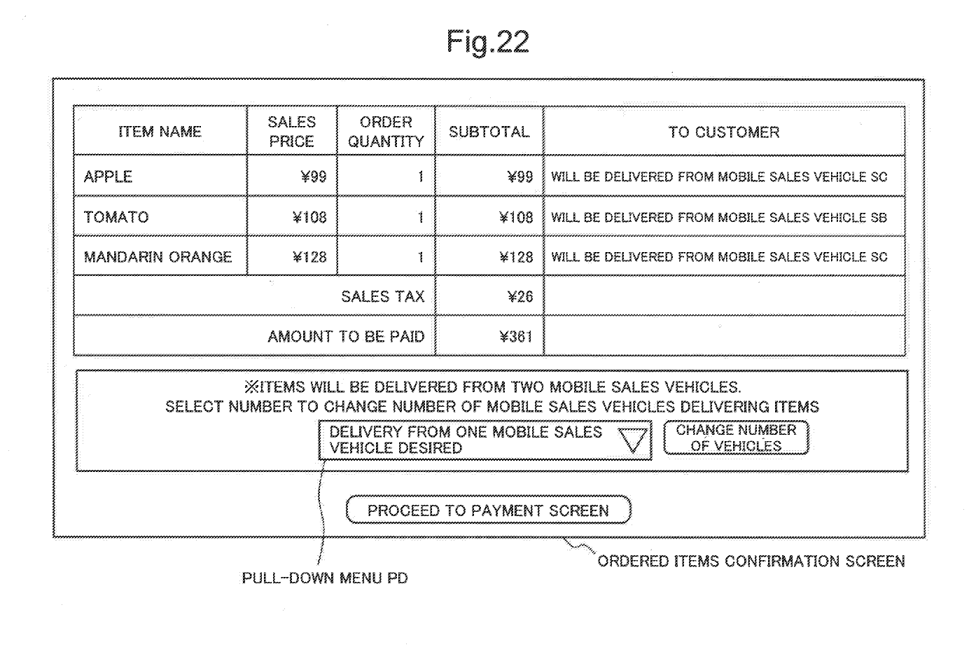

When a number of mobile sales vehicles being to deliver items is two or more as illustrated in FIG. 21, the control unit 330 may get the number displayed in a selectable manner. FIG. 22 illustrates an example of a screen displayed on the display unit 340 at this time. As illustrated in FIG. 22, the control unit 330 may cause the display unit 340 to display a pull-down menu PD allowing a customer to select the number of mobile sales vehicles being to deliver the items.

Then, when the number of mobile sales vehicles is designated by the customer, the transmission unit 310 may transmit a delivery request including the designated number to the stock management device 100. The delivery request is a request for delivery of items from fewer mobile sales vehicles than the mobile sales vehicles delivering the items displayed by the customer on the ordered items confirmation screen. By the delivery request, it is possible that, for example, a mobile sales vehicle can deliver items desired to purchase to a user preferring to lessen visits by a clerk of a mobile sales vehicle with being visits by a clerk of a mobile sales vehicle lessened.

The second reception unit 140 in the stock management device 100 receives the delivery request from the customer terminal 300. As described above, a number of mobile sales vehicles displayed on the ordered items confirmation screen is the number of mobile sales vehicles specified by the second specification unit 190. The second reception unit 140 provides the number of mobile sales vehicles included in the received delivery request to the second specification unit 190. Then, the second specification unit 190 specifies mobile sales vehicles in such a way that the number of mobile sales vehicles being to deliver the ordered items to the customer becomes less than or equal to the number of mobile sales vehicles included in the delivery request.

With such a configuration, the customer can receive ordered items from mobile sales vehicles the number of which is less than or equal to the designated number.

Further, for example, when the number of mobile sales vehicles being to deliver items is lessened than the number of mobile sales vehicles initially specified by the second specification unit 190, the items may not be delivered by a desired delivery time. A case of delivery from one mobile sales vehicle being desired will be described with reference to the screen illustrated in FIG. 22. It is assumed that the mobile sales vehicle SB holds “APPLE” and “TOMATO” but does not hold “MANDARIN ORANGE.” Further, the mobile sales vehicle SC holds “APPLE” and “MANDARIN ORANGE” but does not hold “TOMATO.” Accordingly, when the items are to be delivered by one mobile sales vehicle, the mobile sales vehicle SB needs to go to another mobile sales vehicle or a location for restocking items (for example, a real store or a warehouse) and restock “MANDARIN ORANGE.” Further, when the items are to be delivered by one mobile sales vehicle, the mobile sales vehicle SC needs to go to another mobile sales vehicle or a location for restocking items (for example, a real store or a warehouse) and restock “TOMATO.”

In this case, the second specification unit 190 specifies a mobile sales vehicle delivering the item fastest to a delivery address also taking information about the location for restocking items into consideration. Then, the second specification unit 190 calculates a time by which the specified mobile sales vehicle can deliver the items to the delivery address. When the calculation result is earlier than the desired delivery time, the second specification unit 190 transmits information indicating the specified mobile sales vehicle to the customer terminal 300 through the first transmission unit 130. Further, when the calculation result is later than the desired delivery time, the second specification unit 190 transmits a notification notifying the above to the customer terminal 300 through the first transmission unit 130.

Then, when receiving the notification described above, the customer terminal 300 causes the display unit 340 to display a message screen indicating that the items cannot be delivered by the desired delivery time with the designated number of mobile sales vehicle.

With such a configuration, a customer terminal 300 enables a customer to select whether to give priority to a desired delivery time or give priority to a number of mobile sales vehicles performing delivery, with regard to delivery of items. Consequently, for example, for a customer who prefers to collectively receive items at a time even when delivery of the items becomes later than a desired delivery time, inconvenience of the item arriving from each of a plurality of mobile sales vehicles can be reduced. Further, for example, for a customer who prefers to receive items by a desired delivery time, the items can be securely delivered by the desired delivery time although the items may arrive from a plurality of mobile sales vehicles.

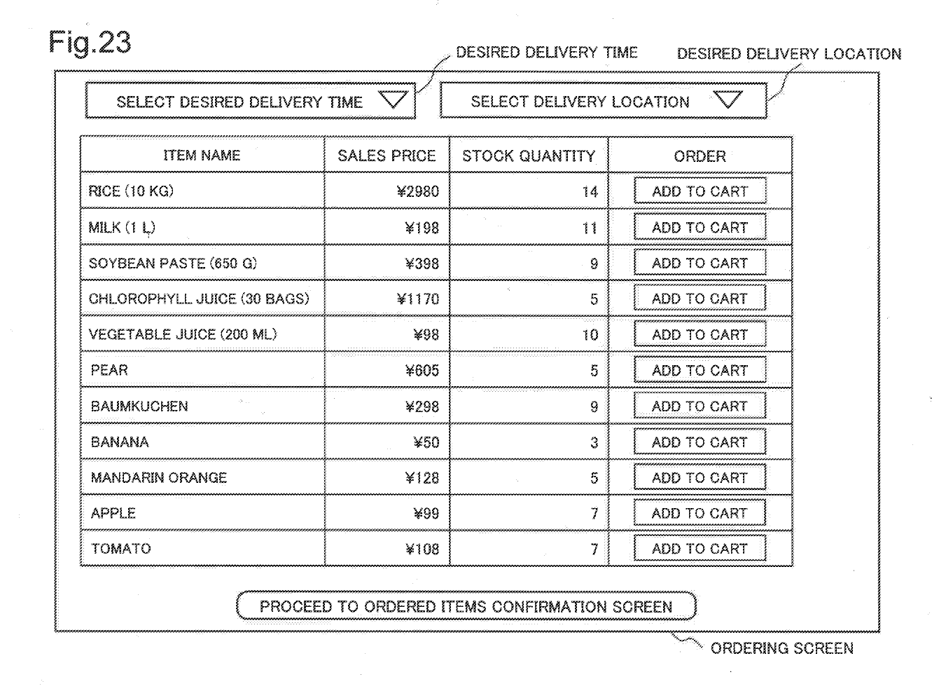

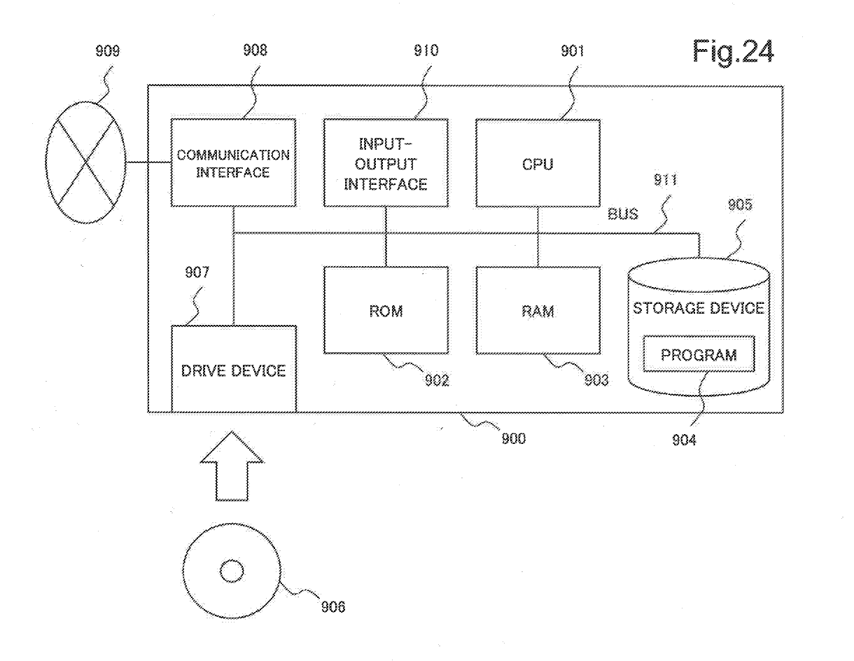

Furthermore, for example, a customer terminal 300 may display information of delivery locations (desired delivery locations) in such a way that the delivery locations can be input (can be selected), as illustrated in FIG. 23. At this time, the control unit 330 may get a time period in which a customer desires delivery displayed on a screen as a desired delivery time. For example, when a customer using the customer terminal 300 desires to receive an item at a point PA or a point PB illustrated in FIG. 8 in a certain time period, the customer inputs the information. Consequently, the first specification unit 180 in the stock management device 100 specifies a mobile sales vehicle capable of delivering the item to the designated location in the designated time period. Then, the reception unit 320 can get stock information about stock held by the mobile sales vehicle specified by the first specification unit 180 displayed on the screen. Consequently, for example, the customer can receive a purchased item at a desired location in a desired time period, even when the customer is away from home.

Furthermore, the stock management device 100 may transmit, to a customer terminal 300, sales state information indicating whether or not an on-board device 200 sells items, and the customer terminal 300 may display a screen based on the sales state information. The customer terminal 300 may further receive, from the stock management device 100, information indicating an item of which a customer using a mobile sales vehicle is considering purchase and display that the customer is considering purchase of the item.

Consequently, the customer terminal 300 enables a customer doing online shopping to understand an item which is likely to be purchased at a storefront of a mobile sales vehicle.

### About Hardware Configuration

Each component in each of the stock management device, the on-board device, and the customer terminal, according to the respective example embodiments of the present disclosure, represents a functional unit block. For example, each component in each of the stock management device, the on-board device, and the customer terminal is implemented in part or in whole with any combination of an information processing device 900 as illustrated in FIG. 28 and a program. FIG. 28 is a block diagram illustrating a hardware configuration example of the information processing device 900 implementing each component in each of the stock management device, the on-board device, and the customer terminal. As an example, the information processing device 900 includes a configuration as described below.
A central processing unit (CPU) 901
A read only memory (ROM) 902
A random access memory (RAM) 903
A program 904 loaded into the RAM 903
A storage device 905 storing the program 904
A drive device 907 performing reading from and writing to a recording medium 906
A communication interface 908 connected to a communication network 909
An input-output interface 910 performing input and output of data
A bus 911 connecting the respective components

Each component in each of the stock management device, the on-board device, and the customer terminal, according to the respective example embodiments, is implemented by the CPU 901 acquiring and executing the program 904 implementing a function of the component. For example, the program 904 implementing the function of each component in each of the stock management device, the on-board device, and the customer terminal is pre-stored in the storage device 905 or the ROM 902, and is read by the CPU 901 as needed. The program 904 may be provided to the CPU 901 through the communication network 909; or the program may be pre-stored in the recording medium 906, and the drive device 907 may read the program and provide the program to the CPU 901.

There are various modified examples of the implementation method of each of the stock management device, the on-board device, and the customer terminal. For example, each of the stock management device, the on-board device, and the customer terminal may be implemented with any combination of a separate information processing device 900 and a program, for each component. Further, a plurality of components included in each of the stock management device, the on-board device, and the customer terminal may be implemented with any combination of a single information processing device 900 and a program.

Further, each component in each of the stock management device, the on-board device, and the customer terminal is implemented in part or in whole with another general-purpose or dedicated circuit, a processor, or the like, or a combination thereof. The above may be configured with a single chip or may be configured with a plurality of chips connected through a bus.

Each component in each of the stock management device, the on-board device, and the customer terminal may be implemented in part or in whole with a combination of the aforementioned circuit or the like, and a program.

When each component in each of the stock management device, the on-board device, and the customer terminal is implemented in part or in whole with a plurality of information processing devices, circuits, or the like, the plurality of information processing devices, circuits, or the like may be arranged in a concentrated manner or be arranged in a distributed manner. For example, the information processing devices, the circuits, or the like may be implemented in a form of being connected to one another through a communication network, such as a client-server system, a cloud computing system, or the like.

The respective aforementioned example embodiments are preferred example embodiments of the present disclosure, and the scope of the present disclosure is not limited to the respective aforementioned example embodiments; and a person skilled in the art can make example embodiments which include various changes through modifying and substituting the respective aforementioned example embodiments without departing from the spirit and scope of the present disclosure.

The aforementioned example embodiments may also be described in whole or in part as the following supplementary notes but are not limited thereto.

### (Supplementary Note 1)

A stock management device comprising:

management means for managing stock information about stock of an item held by each of a plurality of mobile sales vehicles performing mobile sale;

first reception means for receiving, from each of the plurality of mobile sales vehicles, sales information indicating an item sold at a storefront of the mobile sales vehicle and current position information indicating a current position of the mobile sales vehicle;

second reception means for receiving, from a customer terminal, order information including information about an item ordered based on the stock information transmitted to the customer terminal, the second reception means further receiving, from the customer terminal, desired delivery time information at which a customer desires the item to be delivered and delivery address information indicating a delivery address of the item;

first specification means for specifying, when the second reception means receives information indicating the desired delivery time, a mobile sales vehicle capable of delivering the item to the delivery address by the desired delivery time, based on the current position of the mobile sales vehicle indicated by the current position information, and a position of the delivery address indicated by the delivery address information;

first transmission means for transmitting the stock information to the customer terminal, the first transmission means transmitting, to the customer terminal, the stock information about stock held by the mobile sales vehicle specified by the first specification means; and

second transmission means for transmitting the order information along with the delivery address information to the mobile sales vehicle delivering the ordered item, wherein

the management means updates the stock information, based on at least one of the sales information and the order information.

### (Supplementary Note 2)

The stock management device according to Supplementary note 1, wherein

the second reception means further receives, from the customer terminal, a transmission request of information about a mobile sales vehicle delivering the item ordered based on the stock information,

the stock management device further comprises second specification means for specifying, based on the current position of the mobile sales vehicle and the position of the delivery address, a mobile sales vehicle delivering the ordered item fastest to the delivery address, out of the mobile sales vehicles holding the item, and

the first transmission means transmits information about the specified mobile sales vehicle to the customer terminal.

### (Supplementary Note 3)

The stock management device according to Supplementary note 2, wherein,

when a number of the mobile sales vehicles specified by the second specification means is more than two, the second reception means receives, from the customer terminal, a delivery request for delivery of the item from fewer mobile sales vehicles than the mobile sales vehicles specified, and

the second specification means specifies the mobile sales vehicle in such a way that a number of the mobile sales vehicles delivering the ordered item to the customer is fewer than or equal to a number of the mobile sales vehicles included in the delivery request.

### (Supplementary Note 4)

The stock management device according to any one of Supplementary notes 1 to 3, wherein

the order information includes information indicating a mobile sales vehicle delivering the item, and

the second transmission means transmits the order information to the mobile sales vehicle indicated by the information indicating the mobile sales vehicle.

### (Supplementary Note 5)

A customer terminal comprising:

transmission means for transmitting desired delivery time information of an item a customer desires delivery and delivery address information indicating a delivery address of then item to a stock management device managing stock information about stock of an item held by each of a plurality of mobile sales vehicles performing mobile sale;

reception means for receiving, from the stock management device, stock information about stock held by a mobile sales vehicle capable of delivering the item to the delivery address by the desired delivery time; and

display control means for causing a display device to display the desired delivery time in a selectable manner and further causing the display device to display an ordering screen for receiving an order from a customer, the ordering screen being generated based on the stock information.

### (Supplementary Note 6)

The customer terminal according to Supplementary note 5, wherein

the transmission means transmits, to the stock management device, a transmission request of information about a mobile sales vehicle delivering the item ordered based on the stock information,

the reception means receives, as a response to the transmission request, information about the mobile sales vehicle specified based on a current position of the mobile sales vehicle and a position of the delivery address, and delivering the item fastest to the delivery address, and

the display control means gets the mobile sales vehicle being to deliver the item fastest to the delivery address displayed in an understandable manner for the customer based on the received information about the mobile sales vehicle.

### (Supplementary Note 7)

The customer terminal according to Supplementary note 6, wherein,

when the received information about the mobile sales vehicle includes information about more than two mobile sales vehicles, the transmission means transmits a delivery request for delivery of the item from fewer mobile sales vehicles than the mobile sales vehicles specified,

as a response to the delivery request, the reception means receives information about fewer than or equal to mobile sales vehicles included in the delivery request, and

the display control means gets the mobile sales vehicle being to deliver the item fastest to the delivery address displayed in an understandable manner for the customer based on the received information indicating the mobile sales vehicles.

### (Supplementary Note 8)

An item sales system comprising:

a stock management device;

an on-board device being loaded on each of a plurality of mobile sales vehicles performing mobile sale and transmitting, to a stock management device, sales information indicating an item sold at a storefront of each of the plurality of mobile sales vehicles and current position information indicating a current position of the mobile sales vehicle; and

one or more customer terminals, wherein

the stock management device includes:
management means for managing stock information about stock of an item held by each of the plurality of mobile sales vehicles;
first reception means for receiving the sales information and the current position information from each of the plurality of mobile sales vehicles;
second reception means for receiving, from the customer terminal, order information including information about an item ordered based on the stock information transmitted to the customer terminal, the second reception means further receiving, from the customer terminal, desired delivery time information at which a customer desires the item to be delivered and delivery address information indicating a delivery address of the item;
first specification means for specifying, when the second reception means receives information indicating the desired delivery time, a mobile sales vehicle capable of delivering the item to the delivery address by the desired delivery time, based on the current position of the mobile sales vehicle indicated by the current position information, and a position of the delivery address indicated by the delivery address information;
first transmission means for transmitting the stock information to the customer terminal, the first transmission means transmitting, to the customer terminal, the stock information about stock held by the mobile sales vehicle specified by the first specification means; and
second transmission means for transmitting the order information to the mobile sales vehicle delivering the ordered item, wherein

the management means updates the stock information, based on at least one of the sales information and the order information.

### (Supplementary Note 9)

The item sales system according to Supplementary note 8, wherein

the second reception means further receives, from the customer terminal, a transmission request of information about a mobile sales vehicle delivering the item ordered based on the stock information,

the stock management device further comprises second specification means for specifying, based on the current position of the mobile sales vehicle and the position of the delivery address, a mobile sales vehicle delivering the ordered item fastest to the delivery address, out of the mobile sales vehicles holding the item, and

the first transmission means transmits information about the specified mobile sales vehicle to the customer terminal.

### (Supplementary Note 10)

A stock management method comprising:

managing stock information about stock of an item held by each of a plurality of mobile sales vehicles performing mobile sale;

receiving, from each of the plurality of mobile sales vehicles, sales information indicating an item sold at a storefront of the mobile sales vehicle and current position information indicating a current position of the mobile sales vehicle;

transmitting the stock information to a customer terminal;

receiving, from the customer terminal, desired delivery time information at which a customer desires an item to be delivered;

receiving, from the customer terminal, delivery address information indicating a delivery address of the item;

specifying when receiving information indicating the desired delivery time, a mobile sales vehicle capable of delivering the item to the delivery address by the desired delivery time, based on the current position of the mobile sales vehicle indicated by the current position information, and a position of the delivery address indicated by the delivery address information;

transmitting, to the customer terminal, the stock information about stock held by the mobile sales vehicle specified;

receiving, from the customer terminal, order information including information about an item ordered based on the stock information;

transmitting the order information along with the delivery address information to the mobile sales vehicle delivering the ordered item; and

updating the stock information, based on at least one of the sales information and the order information.

### (Supplementary Note 11)

The stock management method according to Supplementary note 10, further comprising:

further receiving, from the customer terminal, a transmission request of information about a mobile sales vehicle delivering the item ordered based on the stock information;

specifying, based on a current position of the mobile sales vehicle and a position of the delivery address, a mobile sales vehicle delivering the ordered item fastest to the delivery address, out of the mobile sales vehicles holding the item; and

transmitting, to the customer terminal, information about a mobile sales vehicle delivering the specified item fastest to the delivery address.

### (Supplementary Note 12)

A display control method comprising:

causing a display device to display a desired delivery time of an item in a selectable manner;

transmitting information indicating a selected desired delivery time and delivery address information indicating a delivery address of the item to a stock management device managing stock information about stock of an item held by each of a plurality of mobile sales vehicles performing mobile sale;

receiving, from the stock management device, stock information about stock held by a mobile sales vehicle capable of delivering the item to the delivery address by the desired delivery time; and

causing the display device to display an ordering screen for receiving an order from a customer, the ordering screen being generated based on the stock information.

### (Supplementary Note 13)

The display control method according to Supplementary note 12, further comprising:

transmitting, to the stock management device, a transmission request of information about a mobile sales vehicle delivering the item ordered based on the stock information;

receiving, as a response to the transmission request, information about the mobile sales vehicle specified based on a current position of the mobile sales vehicle and a position of the delivery address, and delivering the item fastest to the delivery address; and,

getting the mobile sales vehicle being to deliver the item fastest to the delivery address displayed in an understandable manner for the customer based on the received information about the mobile sales vehicle.

### (Supplementary Note 14)

A stock management method in an item sales system including a stock management device, an on-board device loaded on each of a plurality of mobile sales vehicles performing mobile sale, and one or more customer terminals, the stock management method comprising:

managing, by the stock management device, stock information about stock of an item held by each of the plurality of mobile sales vehicles;

transmitting, by the on-board device, to the stock management device, sales information indicating an item sold at a storefront of the mobile sales vehicle loaded with the on-board device and current position information indicating a current position of the mobile sales vehicle;

receiving, by the stock management device, the sales information and the current position information;

transmitting, by the stock management device, the stock information to the customer terminal;

transmitting, by the customer terminal, desired delivery time information of an item a customer desires delivery;

transmitting, by the customer terminal, delivery address information indicating a delivery address of the item;

receiving, by the stock management device, information indicating the desired delivery time from the customer terminal;

receiving, by the stock management device, delivery address information indicating a delivery address of the item from the customer terminal;

based on a current position of the mobile sales vehicle indicated by the current position information, and a position of the delivery address indicated by the delivery address information, specifying, by the stock management device, a mobile sales vehicle capable of delivering the item to the delivery address by the desired delivery time, when receiving information indicating the desired delivery time;

transmitting, by the stock management device to the customer terminal, the stock information about stock held by the specified mobile sales vehicle;

receiving, by the customer terminal, the stock information;

transmitting, by the customer terminal, to the stock management device, order information including information about an item ordered based on the stock information;

receiving, by the stock management device, the order information from the customer terminal;

transmitting, by the stock management device, the order information along with the delivery address information to the mobile sales vehicle delivering the ordered item; and

updating, by the stock management device, the stock information, based on at least one of the sales information and the order information.

### (Supplementary Note 15)

The stock management method according to Supplementary note 14, wherein

the customer terminal
transmits, to the stock management device, a transmission request of information about a mobile sales vehicle delivering the item ordered based on the stock information,

the stock management device
receives the transmission request from the customer terminal,
based on the current position of the mobile sales vehicle and the position of the delivery address, specifies a mobile sales vehicle delivering the ordered item fastest to the delivery address, out of the mobile sales vehicles holding the item, and
transmits, to the customer terminal, information about a mobile sales vehicle delivering the specified item fastest to the delivery address, and

the customer terminal
receives, as a response to the transmission request, information about the specified mobile sales vehicle, and,
based on the received information about the mobile sales vehicle, gets the mobile sales vehicle being to deliver the item fastest to the delivery address displayed in an understandable manner for the customer.

### (Supplementary Note 16)

A computer-readable, non-transitory recording medium recording a program causing a computer to execute:

a process of managing stock information about stock of an item held by each of a plurality of mobile sales vehicles performing mobile sale;

a process of receiving, from each of the plurality of mobile sales vehicles, sales information indicating an item sold at a storefront of the mobile sales vehicle and current position information indicating a current position of the mobile sales vehicle;

a process of receiving, from a customer terminal, order information including information about an item ordered based on the stock information transmitted to the customer terminal;

a process of receiving, from the customer terminal, desired delivery time information at which a customer desires an item to be delivered and delivery address information indicating a delivery address of an item;

a process of specifying, based on a current position of the mobile sales vehicle indicated by the current position information, and a position of the delivery address indicated by the delivery address information, a mobile sales vehicle capable of delivering the item to the delivery address by the desired delivery time, when receiving information indicating the desired delivery time;

a process of transmitting the stock information to the customer terminal;

a process of transmitting, to the customer terminal, the stock information about stock held by the mobile sales vehicle specified;

a process of transmitting the order information along with the delivery address information to the mobile sales vehicle delivering the ordered item; and

a process of updating the stock information, based on at least one of the sales information and the order information. [0205]

### (Supplementary Note 17)

The recording medium according to Supplementary note 16, the program further causing the computer to execute:

a process of further receiving, from the customer terminal, a transmission request of information about a mobile sales vehicle delivering the item ordered based on the stock information;

a process of specifying, based on a current position of the mobile sales vehicles and a position of the delivery address, a mobile sales vehicle being to deliver the ordered item fastest to the delivery address, out of the mobile sales vehicles holding the item; and

a process of transmitting, to the customer terminal, information about the mobile sales vehicle specified.

### (Supplementary Note 18)

A computer-readable, non-transitory recording medium recording a program causing a computer to execute:

a process of transmitting desired delivery time information of an item a customer desires delivery and delivery address information indicating a delivery address of then item to a stock management device managing stock information about stock of an item held by each of a plurality of mobile sales vehicles performing mobile sale;

a process of receiving, from the stock management device, stock information about stock held by a mobile sales vehicle capable of delivering the item to the delivery address by the desired delivery time; and

a process of causing a display device to display the desired delivery time in a selectable manner and further causing the display device to display an ordering screen for receiving an order from a customer, the ordering screen being generated based on the stock information.

### (Supplementary Note 19)

The computer-readable according to Supplementary note 18, the program further causing the computer to execute:

a process of transmitting, to the stock management device, a transmission request of information about a mobile sales vehicle delivering the item ordered based on the stock information,

a process of receiving, as a response to the transmission request, information about the mobile sales vehicle specified based on a current position of the mobile sales vehicle and a position of the delivery address, and delivering the item fastest to the delivery address, and

a process of getting the mobile sales vehicle being to deliver the item fastest to the delivery address displayed in an understandable manner for the customer based on the received information about the mobile sales vehicle.

This application claims priority based on Japanese Patent Application No. 2016-162596 filed on Aug. 23, 2016, the disclosure of which is hereby incorporated by reference thereto in its entirety.

### REFERENCE SIGNS LIST

1 Item sales system
2 Item sales system
10 Stock management device
11 Management unit
12 First reception unit
13 First transmission unit
14 Second reception unit
15 Second transmission unit
16 First specification unit
20 On-board device
30 Customer terminal
31 Transmission unit
32 Reception unit
33 Display control unit
100 Stock management device
110 Management unit
120 First reception unit
130 First transmission unit
140 Second reception unit
150 Second transmission unit
160 Stock information storage unit
170 Customer information storage unit
180 First specification unit
190 Second specification unit
200 On-board device
210 Sales information acceptance unit
220 Transmission unit
230 Positioning unit
240 Reception unit
300 Customer terminal
310 Transmission unit
320 Reception unit
330 Control unit
340 Display unit
350 Acceptance unit

What is claimed is:

1. A stock management device comprising:
a memory storing instructions; and
one or more processors configured to execute the instructions to:
manage stock information about stock of an item held by each of a plurality of mobile sales vehicles performing mobile sale;
receive, from each of the plurality of mobile sales vehicles, sales information indicating an item sold at a storefront of the mobile sales vehicle and current position information indicating a current position of the mobile sales vehicle;
receive, from a customer terminal, order information including information about an item ordered based on the stock information transmitted to the customer terminal, and receive, from the customer terminal, desired delivery time information at which a customer desires the item to be delivered and delivery address information indicating a delivery address of the item;
specify, when information indicating the desired delivery time is received, a mobile sales vehicle capable of delivering the item to the delivery address by the desired delivery time, based on the current position of the mobile sales vehicle indicated by the current position information, and a position of the delivery address indicated by the delivery address information;
transmit the stock information to the customer terminal, and transmit, to the customer terminal, the stock information about stock held by the mobile sales vehicle specified; and
transmit the order information along with the delivery address information to the mobile sales vehicle delivering the ordered item, wherein
the one or more processors are further configured to execute the instructions to:
update the stock information, based on at least one of the sales information and the order information.

2. The stock management device according to claim 1, wherein
the one or more processors are further configured to execute the instructions to:
receive, from the customer terminal, a transmission request of information about a mobile sales vehicle delivering the item ordered based on the stock information,
specify, based on the current position of the mobile sales vehicle and the position of the delivery address, a mobile sales vehicle delivering the ordered item fastest to the delivery address, out of the mobile sales vehicles holding the item, and
transmit information about the specified mobile sales vehicle to the customer terminal.

3. The stock management device according to claim 2, wherein,
the one or more processors are further configured to execute the instructions to:
when a number of the mobile sales vehicles specified is more than two, receive, from the customer terminal, a delivery request for delivery of the item from fewer mobile sales vehicles than the mobile sales vehicles specified, and
specify the mobile sales vehicle in such a way that a number of the mobile sales vehicles delivering the ordered item to the customer is fewer than or equal to a number of the mobile sales vehicles included in the delivery request.

4. The stock management device according to claim 1, wherein
the order information includes information indicating a mobile sales vehicle delivering the item, and
the one or more processors are further configured to execute the instructions to:
transmit the order information to the mobile sales vehicle indicated by the information indicating the mobile sales vehicle.

5. A customer terminal comprising:
a memory storing instructions; and
one or more processors configured to execute the instructions to:
transmit desired delivery time information of an item a customer desires delivery and delivery address information indicating a delivery address of then item to a stock management device managing stock information about stock of an item held by each of a plurality of mobile sales vehicles performing mobile sale;
receive, from the stock management device, stock information about stock held by a mobile sales vehicle capable of delivering the item to the delivery address by the desired delivery time; and
cause a display device to display the desired delivery time in a selectable manner and further causing the display device to display an ordering screen for receiving an order from a customer, the ordering screen being generated based on the stock information.

6. The customer terminal according to claim 5, wherein
the one or more processors are further configured to execute the instructions to:
transmit, to the stock management device, a transmission request of information about a mobile sales vehicle delivering the item ordered based on the stock information,
receive, as a response to the transmission request, information about the mobile sales vehicle specified based on a current position of the mobile sales vehicle and a position of the delivery address, and delivering the item fastest to the delivery address, and
get the mobile sales vehicle being to deliver the item fastest to the delivery address displayed in an understandable manner for the customer based on the received information about the mobile sales vehicle.

7. The customer terminal according to claim 6, wherein,
the one or more processors are further configured to execute the instructions to:
when the received information about the mobile sales vehicle includes information about more than two mobile sales vehicles, transmit a delivery request for delivery of the item from fewer mobile sales vehicles than the mobile sales vehicles specified,
as a response to the delivery request receive information about fewer than or equal to mobile sales vehicles included in the delivery request, and
get the mobile sales vehicle being to deliver the item fastest to the delivery address displayed in an understandable manner for the customer based on the received information indicating the mobile sales vehicles.

8.-9. (canceled)

10. A stock management method comprising:
managing stock information about stock of an item held by each of a plurality of mobile sales vehicles performing mobile sale;
receiving, from each of the plurality of mobile sales vehicles, sales information indicating an item sold at a storefront of the mobile sales vehicle and current position information indicating a current position of the mobile sales vehicle;
transmitting the stock information to a customer terminal;
receiving, from the customer terminal, desired delivery time information at which a customer desires an item to be delivered;
receiving, from the customer terminal, delivery address information indicating a delivery address of the item;
specifying when receiving information indicating the desired delivery time, a mobile sales vehicle capable of delivering the item to the delivery address by the desired delivery time, based on the current position of the mobile sales vehicle indicated by the current position information, and a position of the delivery address indicated by the delivery address information;
transmitting, to the customer terminal, the stock information about stock held by the mobile sales vehicle specified;
receiving, from the customer terminal, order information including information about an item ordered based on the stock information;
transmitting the order information along with the delivery address information to the mobile sales vehicle delivering the ordered item; and
updating the stock information, based on at least one of the sales information and the order information.

11. The stock management method according to claim 10, further comprising:
further receiving, from the customer terminal, a transmission request of information about a mobile sales vehicle delivering the item ordered based on the stock information;
specifying, based on a current position of the mobile sales vehicle and a position of the delivery address, a mobile sales vehicle delivering the ordered item fastest to the delivery address, out of the mobile sales vehicles holding the item; and
transmitting, to the customer terminal, information about a mobile sales vehicle delivering the specified item fastest to the delivery address.

12.-19. (canceled)
